(19) United States
(12) Patent Application Publication
(10) Pub. No.: US 2010/0255162 A1
(43) Pub. Date: Oct. 7, 2010

(54) Packaging with on-demand oxygen generation

(75) Inventors: Michael Becraft, Greer, SC (US); Slawomir Opuszko, Duncan, SC (US); Jason C. Yarbrough, Spartanburg, SC (US); Eugenio Longo, Rho (Milan) (IT); Paolo Guidotti, Oleggio Castello (Novara) (IT); Cynthia L. Ebner, Greer, SC (US); Drew V. Speer, Simpsonville, SC (US)

Correspondence Address: Cryovac, Inc., P.O. Box 464, Duncan, SC, 29334, US

(73) Assignee: Cryovac, Inc.

(21) Appl. No.: 12/384,544

(22) Filed: Apr. 6, 2009

(51) Int. Cl. B65D 81/28; A23L 1/272; A23B 4/16; B65D 85/00; B65B 5/00

(52) U.S. Cl. 426/264; 206/525; 53/467

(57) ABSTRACT

The presently disclosed subject matter is directed to a system and method that allows on-demand oxygen generation within a package. Particularly, the disclosed package incorporates a mass of an oxygen generating material within the interior or exterior of the package. The oxygen generating material is contained by some means, for example, in a cartridge, pouch, sachet, or other similar article separate from a packaged product. For applications with fresh red meat, at the time the package is ready for display, oxygen generation is initiated to increase the oxygen concentration within the package interior, thereby allowing blooming of the red meat.

### BACKGROUND

Meat color is an important characteristic of packaged meat products that affects merchantability. Particularly, consumers often use color as an indicator of meat quality and freshness. The color of meat is related to the amount and chemical state of myoglobin therein. Myoglobin is present in the muscle tissue of all animals and functions to store and deliver oxygen by reversibly binding molecular oxygen, thereby creating an intracellular source of oxygen for the mitochondria. Pork and poultry typically contain lower amounts of myoglobin compared to beef and thus are lighter in color.

Myoglobin includes an open binding site called “heme” that can bind certain small molecules, such as molecular oxygen or water. Particularly, the color of a meat product changes based on the amount of myoglobin present and the amount and type(s) of ligand molecule(s) bound to the heme binding site. For example, myoglobin without a molecule bound to the heme site results in a purple-colored molecule called deoxymyoglobin. Further, when oxygen binds to the heme pocket, purple deoxymyoglobin becomes oxymyoglobin, characterized by a red color. In addition, when a water molecule binds to the heme site, the myoglobin molecule turns brown and is referred to as metmyoglobin.

In packaging of fresh red meat products, it is common practice to initially cut and package the meat at a processing facility for subsequent shipment to retail outlets. Typically, the meat products are packaged such that ambient air is contained within the package, which can result in discoloration of the meat caused by the conversion of myoglobin to a grayish or brownish metmyoglobin. The discoloration generally renders the meat product unacceptable for consumers. In addition, such exposure to ambient air can ultimately result in spoilage of the meat.

Commonly, meat products are packaged using tray-type arrangements. Such packages are substantially prepared and packaged for end-use at the site of final sale. In tray-type packaging, a processed meat product is placed in a tray of suitable material, such as expanded polystyrene, and then sealed within the tray using an overwrap material comprising a thin plastic film. The film is permeable to oxygen such that the color of the meat quickly blooms to a bright red. However, the shelf life of the bright red color is only about three days. Thus, such a packaging format can be undesirable as the color of the meat often becomes unacceptable before it is sold, even though the meat remains nutritious and healthy for consumption. Accordingly, due to the relatively short shelf life, traditional overwrap tray-type packaging is generally not used for meat products packaged at a centralized processing facility. Rather, the meat products must be processed to final form and packaged at the retail outlet.

In order to avoid discoloration and spoilage of meat products and to provide desirable aging, the meat product can be vacuum packaged to remove ambient air and any other undesirable atmosphere. Thus, meat can be packaged in a container that is vacuum-sealed to prevent oxygen contact with the meat until the package is opened. Vacuum-sealed red meat products are nutritious, healthy, and have a long shelf life. However, the meat can have an undesirable purple color in the package that does not bloom to a desirable red color until the meat is exposed to air. Consumer acceptance of purple-colored meat is less than that of meat having a red color. Accordingly, vacuum packaging of meat products is considered less than optimal for several reasons. First, vacuum packaging is a relatively expensive process requiring specialized equipment. Second, vacuum packaging produces an end product wherein a film wrap material is in contact with a meat product, resulting in an irregularly shaped package that is undesirable from the standpoint of product presentation. Further, vacuum packaged meat products do not have the deep red color desired by consumers.

Alternatively, to provide the consumer-preferred red color, meat can be packaged in a modified atmosphere package (“MAP”), wherein the meat is maintained in a sealed pocket containing an atmosphere that is different than ambient air. In these controlled atmosphere packaging systems, the meat product is generally placed in a deep tray of suitable material and the top of the tray above the level of the meat product is sealed with a suitable film, leaving a relatively large amount of open space around the meat. A preferred atmosphere is then placed in the open space within the tray to produce a desired effect on the color of the meat product. Packaging fresh meat products with an inert gas atmosphere has been found to be an acceptable way to preserve the meat product and provide desirable aging after shipment of the meat from a processing facility to a retail outlet. However, once the package has arrived at the retail outlet, it is necessary to replace the inert gas atmosphere within the package with an oxygen-containing atmosphere. Thus, any discoloration on the surface of the meat product that may have been caused by the presence of the inert gas atmosphere is removed and a deep red color on the surface of the meat product is produced. However, MAP suffers from increased labor and packaging costs at the retail facility. Current MAP systems are also relatively more expensive than traditional tray-type packaging and chub packaging. In addition, MAP systems require that packaging space be taken up by the desired atmosphere such that relatively less product can be stored in a given space as compared to traditional packaged products.

The description of the presently disclosed subject matter is discussed herein primarily in relation to meat products whose associated packaging problems are typical of those which the presently disclosed subject matter considers. However, it should be appreciated that the presently disclosed subject matter can also be applied to other oxygen-sensitive foodstuffs and articles to be packaged.

### SUMMARY

In some embodiments, the presently disclosed subject matter is directed to a package that enables on-demand oxygen generation within the interior of the package. In some embodiments, the package comprises an article that encompasses an enclosed space, a product disposed within said article, and an oxygen generating device disposed on an interior or exterior surface of the article. In some embodiments, said oxygen generating device comprises two or more components that can react on demand to produce oxygen. In some embodiments, said oxygen generating device comprises a means to allow oxygen to flow into the interior of the article.

In some embodiments, the presently disclosed subject matter is directed to a method of packaging a product in an article that enables on-demand oxygen generation within the interior of the article. In some embodiments, the method comprises supplying an article that encompasses an enclosed space and disposing a product within the interior of said article. In some embodiments, an oxygen generating device is then disposed on an interior or exterior surface of the article. In some embodiments, the oxygen generating device comprises two or more components that can react on demand to produce oxygen. In some embodiments, said oxygen generating device comprises a means to allow oxygen to flow into the interior of the article. In some embodiments, the method then comprises sealing the article and initiating the oxygen generating device to generate oxygen within the interior of the article.

In some embodiments, the presently disclosed subject matter is directed to a method of promoting blooming of fresh red meat. In some embodiment, the method comprises supplying an article that encompasses an enclosed space and disposing an amount of fresh red meat within the interior of said article. In some embodiments, the method then comprises disposing an oxygen generating device on an interior or exterior surface of the article, wherein said oxygen generating device comprises two or more components that can react on demand to produce oxygen. In some embodiments, said oxygen generating device comprises a means to allow oxygen to flow into the interior of the article. In some embodiments, the method then comprises sealing the article and initiating the oxygen generating device to generate oxygen within the interior of the article.

In some embodiments, the presently disclosed subject matter is directed to an article that enables on-demand oxygen generation within the interior of the article. In some embodiments, the article can comprise an enclosed space and an oxygen generating device disposed on an interior or exterior surface of said article. In some embodiments, the oxygen generating device comprises two or more components that can react on demand to generate oxygen. In some embodiments, said oxygen generating device comprises a means to allow oxygen to flow into the interior of the article.

### BRIEF DESCRIPTION OF THE DRAWINGS

FIG. 1a is a perspective view of an on-demand oxygen generating package in accordance with some embodiments of the presently disclosed subject matter.

FIG. 1b is a side elevation view of the package of FIG. 1a.

FIG. 1c is a side elevation view of an on-demand oxygen generating package in accordance with some embodiments of the presently disclosed subject matter.

FIG. 2a is a side elevation view of an on-demand oxygen generating package in accordance with some embodiments of the presently disclosed subject matter.

FIG. 2b is a perspective view of an on-demand oxygen generating package in accordance with some embodiments of the presently disclosed subject matter.

FIG. 3a is a top plan view of oxygen generating device in accordance with some embodiments of the presently disclosed subject matter.

FIG. 3b is a side elevation view of the oxygen generating device of FIG. 3a.

FIG. 3c is a top plan view of an oxygen generating device in accordance with some embodiments of the presently disclosed subject matter.

FIG. 3d is a side elevation view of the oxygen generating device of FIG. 3c.

FIGS. 3e and 3f are top plan views of two embodiments of an oxygen generating device in accordance with the presently disclosed subject matter.

FIGS. 4a and 4b are side elevation views of an oxygen generating device in accordance with some embodiments of the presently disclosed subject matter.

FIG. 4c is a side elevation view of an oxygen generating device in accordance with some embodiments of the presently disclosed subject matter.

FIG. 5a is a side elevation view of an on-demand oxygen generating package in accordance with some embodiments of the presently disclosed subject matter.

FIG. 5b is a perspective view of an on-demand oxygen generating package in accordance with some embodiments of the presently disclosed subject matter.

FIG. 5c is a perspective view of an on-demand oxygen generating package in accordance with some embodiments of the presently disclosed subject matter.

FIG. 5d is a side elevation view of an on-demand oxygen generating package in accordance with some embodiments of the presently disclosed subject matter.

FIGS. 6a and 6b are enlarged fragmentary views of an oxygen generating device according to some embodiments of the presently disclosed subject matter.

FIG. 7 is a line graph depicting the oxygen concentration in two case ready trays after oxygen generation.

FIG. 8 is a line graph depicting a time course of the oxygen generated by 2 g SPC, 5 g SPC, and 2 g SPC +MnO₂.

FIG. 9 is a line graph depicting a time course of the amount of oxygen generated after adding varying amounts of water to 2 g SPC+MnO₂.

FIG. 10 is a line graph depicting a time course of the percent oxygen in the headspaces of four trays under varying conditions.

### DETAILED DESCRIPTION

### I. General Considerations

The presently disclosed subject matter comprises a system and method that enables on-demand oxygen generation within an article. Particularly, the disclosed system comprises an article, a product disposed within the article, and an oxygen generating device disposed on an internal or external surface of the article. The oxygen generating material is contained by some means; for example, within a cartridge, pouch, sachet, or other similar container separate from the packaged product. At a desired time, oxygen generation is initiated to increase the oxygen concentration within the article.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” can refer to “one or more” when used in the subject specification, including the claims. Thus, for example, reference to “a device” (e.g., “an oxygen generating device”) includes a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed system and methods.

As used herein, the phrase “abuse layer” refers to an outer film layer and/or an inner film layer, so long as the film layer serves to resist abrasion, puncture, and other potential causes of reduction of package integrity, as well as potential causes of reduction of package appearance quality. An abuse layer can comprise any polymer, so long as the polymer contributes to achieving an integrity goal and/or an appearance goal. In some embodiments, an abuse layer can comprise polymers having a modulus of at least 10⁷ Pascals, at room temperature. In some embodiments, an abuse layer can comprise (but is not limited to) polyamide and/or ethylene/propylene copolymer, polypropylene; in some embodiments, nylon 6, nylon 6/6, and/or amorphous nylon.

As used herein, the term “article” refers to an object of manufacture that can be in the form of a web (e.g., monolayer or multilayer films, monolayer or multilayer sheets), bag, shrink bag, bottle, box, jar, pouch, casing, tray, lidded tray, over-wrapped tray, form shrink package, vacuum skin package, flow wrap package, thermoformed package, packaging insert, or combinations thereof. In some embodiments, the article can be a support member for supporting and containing a product, such as red meat. It will be appreciated by those skilled in the art that such packages can include flexible, rigid, or semi-rigid materials and can be heat shrinkable or non-heat shrinkable, oriented or non-oriented.

As used herein, the terms “barrier” and “barrier layer” (or “impermeable” or “impermeable layer”), as applied to films and/or film layers, refer to the ability of a film or film layer to serve as a barrier to gases and/or odors. Examples of polymeric materials with low oxygen transmission rates useful in such a layer can include: ethylene/vinyl alcohol copolymer (EVOH), polyvinylidene dichloride (PVDC), vinylidene chloride copolymer such as vinylidene chloride/methyl acrylate copolymer, vinylidene chloride/vinyl chloride copolymer, polyamide, polyester, polyacrylonitrile (available as Barex™ resin), or blends thereof. Oxygen barrier materials can further comprise high aspect ratio fillers that create a tortuous path for permeation (e.g., nanocomposites). Oxygen barrier properties can be further enhanced by the incorporation of an oxygen scavenger, such as an organic oxygen scavenger. In some embodiments, metal foil, metallized substrates (e.g., metallized polyethylene terephthalate ((PET)), metallized polyamide, and/or metallized polypropylene), and/or coatings comprising SiOx or AlOx compounds can be used to provide low oxygen transmission to a package. In some embodiments, a barrier layer can preferably have a gas (e.g., oxygen) permeability of less than or equal to about 500 cc/m²/24 hrs/atm at 73° F., more preferably less than about 100 cc/m²/24 hrs/atm at 73° F., more preferably still less than about 50 cc/m²/24 hrs/atm at 73° F., and most preferably less than about 25 cc/m²/24 hrs/atm at 73° F.

The term “bulk layer” as used herein refers to a layer used to increase the abuse-resistance, toughness, modulus, etc., of a film. In some embodiments, the bulk layer can comprise polyolefin (including but not limited to) at least one member selected from the group comprising ethylene/alpha-olefin copolymer, ethylene/alpha-olefin copolymer plastomer, low density polyethylene, and/or linear low density polyethylene and polyethylene vinyl acetate copolymers.

The term “case ready” refers to a package that is pre-packaged and/or labeled at a centralized location and delivered to a retail market in a format whereby it is ready for immediate display and sale. A case ready package actively extends the quality life of a product (for example, a fresh meat product) to allow for the extra time that it takes to be packaged at a centrally located facility, distributed to the retail market, and then displayed for consumer selection and purchase.

As used herein, the phrase “easy open” refers to any means for accessing the contents of a package that obviates the need to cut and/or pierce the package with a knife, scissors, or any other sharp implement. An easy open feature can be in at least one portion of the web used to form a package and can include one or more cuts, notches, or surface-roughened areas, lines of structural weakness, or combinations thereof. Examples of such easy open features are described in U.S. Patent Application Publication Nos. 2005/0084636 to Papenfuss et al. and 2005/0254731 to Berbert et al., both of which are incorporated herein in their entireties. In some embodiments, the easy open feature can include one or more frangible or peelable layers adapted to manually separate or delaminate at least a portion of the web used to form the package, as described in U.S. Reissued Pat. No. RE37,171 to Busche et al., which is incorporated herein in its entirety. It will be appreciated that in some embodiments peelable webs can further comprise one or more reclosable peelable layers. Examples of still other alternative easy open features include reclosable interlocking fasteners attached to at least a portion of the web used to form the package. Reclosable fasteners, in general, are known and are taught, for example, in U.S. Pat. Nos. 5,063,644; 5,301,394; 5,442,837; 5,964,532; 6,409,384; 6,439,770; 6,524,002; 6,527,444; 6,609,827; 6,616,333; 6,632,021; 6,663,283; 6,666,580; 6,679,027; and U.S. Patent Application Nos. 2002/0097923; and 2002/0196987, all hereby incorporated by reference in their entireties.

As used herein, the term “exterior layer” refers to a layer comprising the outermost surface of a web or product. For example, an exterior layer can form the exterior surface of a package that contacts the exterior layer of another package during overlapping heat sealing of two packages.

As used herein, the term “film” includes, but is not limited to, a laminate, sheet, web, coating, and/or the like, that can be used to package a product. The film can be a rigid, semi-rigid, or flexible product, and can be adhered to a non-polymeric or non-thermoplastic substrate such as paper or metal to form a rigid, semi-rigid, or flexible product or composite.

The terms “food contact layer” and/or “food contact surface” refer to the portion of a packaging material that contacts a packaged product, such as for example, meat.

The term “interior layer” as used herein refers to a layer comprising the innermost surface of a web or product. For example, an interior layer can form the interior surface of an enclosed package. In some embodiments, the interior layer can be the food-contact layer and/or the sealant layer.

As used herein, the terms “MAP” and/or “modified atmosphere package” refer to a packaging format wherein a gas is actively flushed into the headspace of a package prior to sealing. In general, the gas is modified to be different from that normally found in the atmosphere outside the MAP. The result is a package with a considerable volume of gas surrounding the viewing surface of a packaged product. An example of such a package is disclosed in, e.g., U.S. Pat. No. 5,686,126 to Noel et al., the entire disclosure of which is hereby incorporated by reference.

The term “meat” or “meat product” refers to any myoglobin-containing or hemoglobin-containing tissue from an animal, such as beef, pork, veal, lamb, mutton, chicken or turkey; and game such as venison, quail, and duck. The meat can be in a variety of forms including primal cuts, subprimal cuts, and/or retail cuts as well as ground, comminuted, or mixed. The meat or meat product is preferably fresh, raw, uncooked meat, but can also be frozen, hard chilled, or thawed. In some embodiments, the meat can be subjected to other irradiative, biological, chemical and/or physical treatments. The suitability of any particular such treatment can be determined without undue experimentation in view of the present disclosure.

As used herein, the term “on demand” refers the ability to allow a user to initiate a particular feature at any desired time. Thus, for example, as used herein, “on demand oxygen generation” refers to the ability of a user to initiate oxygen generation within a package at any desired time.

As used herein, the term “oxygen generating device” refers to any of a wide variety of devices that can be employed to generate oxygen within a package. For example, oxygen generating devices can include (but are not limited to) pouches, sachets, and/or cartridges that house two or more components that can react to produce oxygen (such as, for example, hydrogen peroxide and a catalyst).

The term “oxygen generation” as used herein refers to the production of oxygen by any of the wide variety of natural or artificial processes known in the art. For example, in some embodiments, oxygen generation refers to the production of oxygen resulting from the combination of two or more components, such as (but not limited to) hydrogen peroxide and a catalyst.

As used herein, the term “package” refers to an object of manufacture that can be in the form of a web (e.g., monolayer or multilayer films, monolayer or multilayer sheets), bag, shrink bag, pouch, casing, tray, lidded tray, overwrapped tray, form shrink package, vacuum skin package, flow wrap package, thermoformed package, packaging insert or combinations thereof. It will be appreciated by those skilled in the art that such packages can include flexible, rigid, or semi-rigid materials and can be heat shrinkable or non-heat shrinkable, or oriented or non-oriented. In some embodiments, a package can include an article that encompasses an enclosed space, a product disposed within the container, and an oxygen generating device disposed on an interior or exterior surface of the article.

As used herein, the term “perborate” refers to a compound containing the boron oxoanion BO₃⁻³, formed from a borate and hydrogen peroxide. Perborates can include (but are not limited to) perborate salts of Group I and II metals (i.e., sodium perborate (NaBO₃)). Sodium perborate undergoes hydrolysis when contacted with water, producing hydrogen peroxide and borate.

As used herein, the term “permeable” can refer to films that have a gas (e.g., oxygen) transmission rate of at least about 1,000 cc/m²/24 hrs/atm at 73° F., more preferably at least about 5,000 cc/m²/24 hrs/atm at 73° F., even more preferably at least about 10,000 cc/m²/24 hrs/atm at 73° F., more preferably still at least about 50,000 cc/m²/24 hrs/atm at 73° F., and most preferably at least about 100,000 cc/m²/24 hrs/atm at 73° F. The term “permeable” can also refer to films that do not have such high gas permeability, but that are sufficiently permeable to effect a sufficiently rapid bloom for the particular product and particular end-use application.

The term “peroxide” as used herein refers to any compound containing a bivalent O—O group, i.e., the oxygen atoms are univalent. The peroxy O—O group can be found in both inorganic and organic compounds. Examples of peroxides suitable for use with the presently disclosed subject matter can include (but are not limited to) hydrogen peroxide (H₂O₂, the simplest and most stable peroxide), sodium peroxide (Na₂O₂), lithium peroxide (Li₂O₂), calcium peroxide (CaO₂), and percarbamide (i.e., urea peroxide). Per-acids are also included as peroxides. Examples of per-acids can include (but are not limited to) peracetic acid, performic acid, and persulfuric acid.

As used herein, the term “percarbonate” refers to the stable addition compound of hydrogen peroxide with a metal carbonate salt. Percarbonates suitable for use with the presently disclosed subject matter can include (but are not limited to) sodium percarbonate.

As used herein, the term “polymer” (and specific recited polymers) refer to the product of a polymerization reaction, and is inclusive of homopolymers, copolymers, terpolymers, etc.

As used herein, the term “polymerization” can be inclusive of homopolymerizations, copolymerizations, terpolymerizations, etc., and can include all types of copolymerizations such as random, graft, block, etc. In general, the polymers in the films of the presently disclosed subject matter can be prepared in accordance with any suitable polymerization process, including slurry polymerization, gas phase polymerization, high pressure polymerization processes, and the like.

The term “react” as used herein refers to the process of effecting a molecular change, such as, for example, reacting calcium peroxide and water to produce hydrogen peroxide and calcium hydroxide.

As used herein, the term “seal” refers to any seal of a first region of a film surface to a second region of a film surface, wherein the seal is formed by heating the regions to at least their respective seal initiation temperatures. The heating can be performed by any one or more of a wide variety of manners, such as using a heated bar, hot air, infrared radiation, radio frequency radiation, etc.

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 3 mils of a film can be involved in the sealing of the film to itself or another layer. With respect to packages having only fin-type seals, as opposed to lap-type seals, the phrase “sealant layer” generally refers to the inside film layer of a package, as well as supporting layers adjacent this sealant layer often being sealed to itself, and frequently serving as a food contact layer in the packaging of foods. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

The term “SOD” or “superoxide dismutase” refers to a class of enzymes that catalyze the dismutation of superoxide into oxygen and hydrogen peroxide. SOD is an extremely efficient class of enzyme; it catalyzes the neutralization of superoxide nearly as fast as the two can diffuse together spontaneously in solution.

As used herein, the term “superoxide” can refer to an anion (i.e., a compound characterized by the presence of the O₂⁻¹ ion). The O₂⁻¹ ion has an odd number of electrons (13) and as a result, superoxides are paramagnetic and have a yellowish color at room temperature. Examples of superoxides can include (but are not limited to) sodium superoxide (NaO₂), potassium superoxide (KO₂), calcium superoxide (Ca(O₂)₂), barium superoxide (Ba(O₂)₂), and tetramethylammonium superoxide ((CH₃)₄NO₂). In each of these compounds, the oxygen atom has an oxidation number of (−½) instead of (−2) as in a normal oxide. Upon the addition of water, the dissolved O₂⁻¹ ion undergoes disproportionation (dismutation) very quickly to produce oxygen and hydrogen peroxide, which can then decompose to oxygen and water.

As used herein, the term “tie layer” refers to an internal film layer having the primary purpose of adhering two layers to one another. In some embodiments, tie layers can comprise any nonpolar polymer having a polar group grafted thereon, such that the polymer is capable of covalent bonding to polar polymers such as polyamide and ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

The term “vacuum skin packaging” or “VSP” as used herein refers to a process wherein a thermoformable film (i.e., capable of being formed into a desired shape upon the application of heat) is thermoformed about a product on a tray by means of heat and/or pressure. Virtually all of the air is evacuated from a predefined space around the package so that when the film is attached to the tray about the product and the resultant package is subsequently exposed to atmospheric pressure, the film conforms very closely to the contour of the packaged product. Further details are described in U.S. Pat. No. RE 30,009 to Purdue et al.; U.S. Pat. No. 5,346,735 to Logan et al.; and U.S. Pat. No. 5,770,287 to Miranda et al., the disclosures of which are incorporated by reference herein.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

### III. The Disclosed Package

III.A. Generally

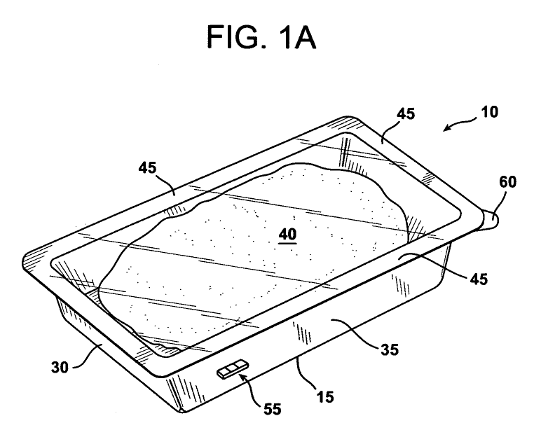

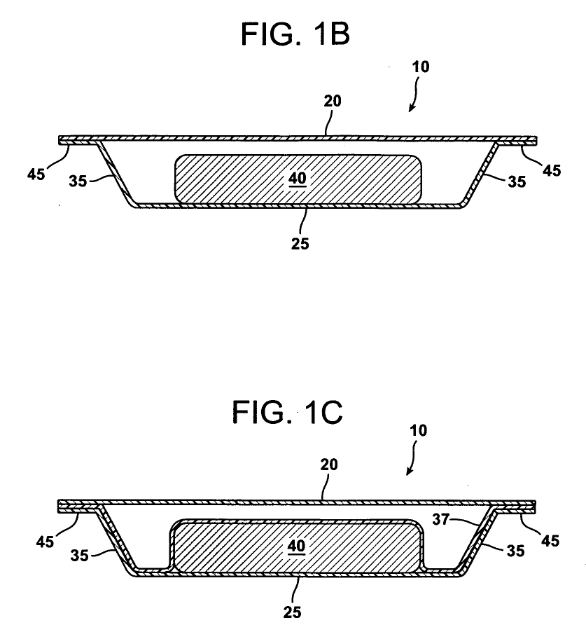

With reference to FIGS. 1a and 1b, package 10 includes an article (which in some embodiments can be tray 15), product 40 disposed within the article, and oxygen generating device 55. Particularly, tray 15 includes bottom wall 25 having a pair of spaced side walls 35 and a pair of spaced end walls 30 extending upwardly therefrom. Side walls 35 and end walls 30 are interconnected with each other and cooperate with bottom wall 25 of tray 15 to define an internal cavity within which product 40 is placed using any conventional means known in the art. Thus, in some embodiments, package 10 can comprise a tray having bottom and side walls defining an interior space with an open top.

In some embodiments, each side wall and end wall 35, 30 of tray 15 can comprise a laterally extending sealing flange 45 at its upper end. Sealing flanges 45 are interconnected with each other to define a peripheral sealing surface to which film 20 can be sealed in any conventional manner (such as by heat sealing) to maintain a desired atmosphere within the tray interior. For example, in some embodiments, it is desired that the internal package atmosphere comprise a low-oxygen environment. At a desired time (such as, for example, at the time of retail display of the package), oxygen generating device 55 can be initiated as set forth in more detail herein below. Accordingly, the presently disclosed package allows for on-demand oxygen generation to increase the oxygen concentration within the enclosed space of an article, such as tray 15.

In some embodiments, as depicted in FIG. 1c, package 10 comprises vacuum skin 37 in addition to film 20. Particularly, vacuum skin 37 is oxygen permeable and is vacuum skin packaged to product 40. During vacuum sealing, vacuum skin 37 shrinks around product 40. Thus, as oxygen is initiated within package 10 using oxygen generating device 55, the oxygen permeates through vacuum skin 37 to contact product 40. Accordingly, “vacuum skin packaging”, “skin packaging”, and/or “VSP” refer not only to the fact that the thermoformable film is formed around the product by vacuum or differential air pressure but also to the fact that the product is packaged under vacuum and the space containing the product is evacuated. Further details are described in U.S. Pat. Nos. RE 30,009 to Purdue et al.; U.S. Pat. No. 5,346,735 to Logan et al.; and U.S. Pat. No. 5,770,287 to Miranda et al., the entire disclosures of which are incorporated herein by reference.

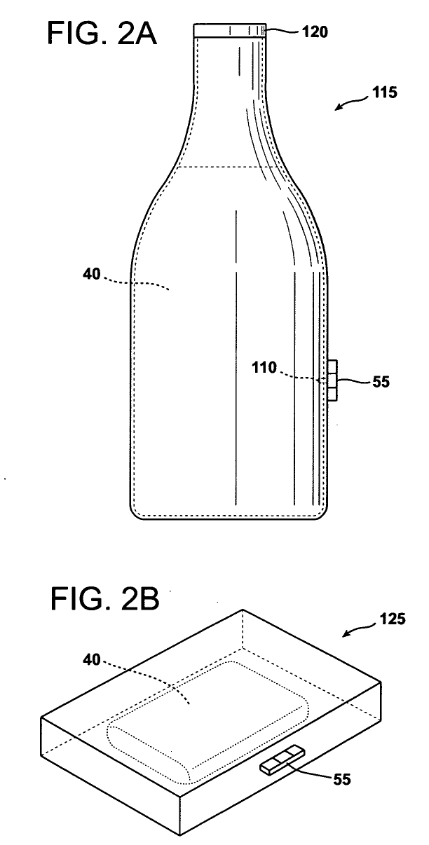

As a variation on the tray depicted in the Figures, the presently disclosed subject matter can also be used with any of a wide variety of articles, such as (but not limited to) a tray, bottle, box, jar, blister package, carton, bag, sachet, pouch, and/or combinations thereof. For example, FIG. 2a depicts bottle 115 containing product 40. Particularly, lid 120 seals bottle 115 to create a closed environment within the interior of the bottle. Bottle 115 can be constructed of any of a wide variety of oxygen-impermeable materials, such as (but not limited to) metal, glass, plastic, and the like. It will be understood that there are to be no limitations as to the dimensions and shape of bottle 115. Bottles are well known to those of ordinary skill in the packaging art. See, for example, U.S. Pat. Nos. 6,171,623 to Gavior; U.S. Pat. No. 6,673,303 to White; and U.S. Pat. No. 5,409,983 to Jones, the entire disclosures of which are incorporated herein in their entireties.

As set forth in more detail herein below, in some embodiments oxygen generating device 55 can be disposed on an outer surface of the bottle (or other packaging article). Thus, oxygen generation can be initiated when a user activates oxygen generating device 55 and the generated oxygen flows through accessing means 110 into the interior of bottle 115. Accordingly, in some embodiments, the oxygen generating device comprises a means to allow oxygen to flow into the interior of a package. For example, the means to allow oxygen to flow into the interior of package can be selected from one or more tubes, perforations, microperforations, holes, frangible seals, slits, and the like. One of ordinary skill in the art would recognize that in some embodiments oxygen generating means 55 can be disposed on an inner surface of a bottle (or other packaging article).

Continuing, as illustrated in FIG. 2b, in some embodiments, the article suitable for use with the presently disclosed subject matter can comprise box 125 containing product 40. Box 125 can be constructed of any of a wide variety of oxygen-impermeable materials, such as (but not limited to) metal, plastic, coated cardboard, treated wood, and the like. In some embodiments oxygen generating means 55 can be disposed on an exterior surface of box 125. After oxygen generation has been initiated, the generated oxygen flows from oxygen generating means 55 through accessing means 110 (not illustrated) into the interior of box 125 to contact product 40. One of ordinary skill in the art would recognize that in some embodiments oxygen generating means 55 can be disposed on an inner surface of box 125. It will be understood that there are to be no limitations as to the dimensions and shape of box 125. Boxes are well known to those of ordinary skill in the packaging art.

Thus, one of ordinary skill in the art would recognize that package 10 can include the wide variety of known packaging articles known in the art, including (but not limited to) trays, bottles, boxes, jars, blister packages, cartons, bags, sachets, pouches, and the like.

II.B. Tray 15

Tray 15 can have any desired configuration or shape, e.g., rectangular, round, oval, and the like. Similarly, flange 45 can have any desired shape or design, including a simple, substantially flat design that presents a single sealing surface as shown in the figures, or a more elaborate design that presents two or more sealing surfaces, as disclosed in U.S. Pat. No. 5,348,752 to Gorlich and U.S. Pat. No. 5,438,132 to Bray et al., the disclosures of which are incorporated herein in their entireties. Flange 45 can also include a peripheral lip positioned adjacent and exterior to the sealing surface to facilitate the peelable delamination of film 20 (i.e., tab 60).

It should be noted herein that tray 15 can be referred to as a “bottom” or forming web, i.e., in normal usage, package 10 can rest on tray 15 such that the bottom web comprises the bottom of the package. Likewise, film 20 can be referred to as a “top” web, i.e., in normal usage, package 10 can be positioned such that the top web comprises the top of the package. Nevertheless, those skilled in the art will understand, after a review of the presently disclosed subject matter, that package 10 can be manufactured, stored, shipped, and/or displayed in any suitable orientation. For example, in some embodiments, package 10 can be placed on a supporting surface such that tray 15 functions as the top of the package and film 20 functions as the bottom of the package.

Although the trays (and other packaging articles) depicted in the enclosed Figures depict only one compartment to house product 40, it is within the scope of the presently disclosed subject matter that the presently disclosed subject matter can include containers formed with one or more compartments to house a plurality of products.

In some embodiments, tray 15 can be impermeable and can be chosen from a variety of commercially available designs and compositions. For example, the tray can be formed from a rigid solid polymer, a barrier sealant coated polymer, a barrier sealant coated foamed polymer, and/or a barrier sealant coated pulp or paperboard tray. If foamed, a barrier film must be included, at least, on the inner surface of the tray in order to prevent outgassing of residual gases into the package.

In some embodiments, tray 15 can be oxygen-permeable and packaged in a barrier overwrap. In these embodiments, the barrier overwrap is capable of completely covering the tray and adhering or clinging to itself or to the tray to complete the packaging closure. Particularly, the product to be packaged is placed in a barrier or non-barrier tray and the overwrap film is then stretched and/or wrapped around the product and tray. In some embodiments, the overwrapped tray can be pressed into a heated plate to weld together the folds of the film at the underside of the tray. Such overwrapped films are well known in the packaging art. See, for example, U.S. Pat. Nos. 6,408,598 to Stockley; U.S. Pat. No. 5,663,002 to Schirmer; U.S. Pat. No. 4,759,444 to Barmore; U.S. Pat. No. 5,018,623 to Hrenyo; and U.S. Pat. No. 5,503,858 to Reskow, the entire disclosures of which are incorporated herein by reference.

Alternatively, in some embodiments, the barrier overwrap can be a bag-like structure such that tray 15 is completely enclosed and sealed within the overwrap. Particularly, a non-barrier or barrier tray can be placed within an outer barrier bag composed of a material that is essentially impervious to oxygen. In some embodiments, the outer barrier bag can be evacuated of normal atmosphere and flushed with a preservation-enhancing gas (such as, for example, CO₂). The outer barrier bag can then be sealed. Such barrier bags are known to those of ordinary skill in the packaging art. See, for example, U.S. Pat. No. 6,716,499 to Vadhar; U.S. Pat. No. 6,544,660 to Lind; U.S. Pat. No. 4,755,402 to Oberle; and U.S. Pat. No. 4,716,061 to Winter, the entire disclosures of which are incorporated herein by reference.

Thus, examples of trays suitable for use in the presently disclosed subject matter are known in the art. See, for example, U.S. Pat. Nos 6,279,738 to Mungo et al.; U.S. Pat. No. 6,415,925 to Fux; U.S. Pat. No. 6,216,855 to Grone; U.S. Pat. No. 5,655,708 to Grone; U.S. Pat. No. 5,050,791 to Bowden et al.; U.S. Pat. No. 4,702,377 to Grone; U.S. Pat. No. 4,623,088 to Holden; U.S. Pat. No. 4,533,585 to Holden; U.S. Pat. No. 4,349,146 to Holden; U.S. Pat. No. 4,057,651 to Florian; and U.S. Pat. No. 3,997,101 to Florian, the entire disclosures of which are incorporated herein in their entireties.

In some embodiments, when products are to be packaged in a low oxygen environment, tray 15 allows less than about 1000 cc of oxygen to pass therethrough; in some embodiments, less than about 500 cc; in some embodiments, less than about 100 cc; in some embodiments, less than about 50 cc per square meter of material per 24 hour period at 1 atmosphere of pressure and at a temperature of 73° F. (at 0% relative humidity). Thus, tray 15 can comprise a material that itself provides a barrier to the passage of oxygen, e.g., vinylidene chloride copolymer, nylon, PET, EVOH copolymer, and the like. Alternatively or in addition, tray 15 can have a substantially gas-impermeable sealant film laminated or otherwise bonded to the inner or outer surface thereof as described in U.S. Pat. Nos. 4,847,148 and 4,935,089 both to Schirmer, the entire disclosures of which are herein incorporated by reference. Any such sealant film can include an oxygen-barrier material such as (but not limited to) vinylidene chloride copolymer, nylon, PET, EVOH copolymer, and the like. In other embodiments, tray 15 can be oxygen-permeable, but can comprise a barrier overwrap.

Tray 15 can comprise a thermoformed foam sheet, a thermoformed or molded rigid sheet tray, or any other support member that can be pre-formed or formed in-line during packaging. Accordingly, in general, tray 15 can comprise any suitable material known to those of ordinary skill in the art, such as (but not limited to) polyolefin. In some embodiments, tray 15 can comprise at least one member selected from the group comprising: polyvinylchloride, high density polyethylene, polystyrene, polypropylene, polyethylene terephthalate (PET), crystalline polyethylene terephthalate (CPET), amorphous polyethylene terephthalate (APET), polyamides (nylons), polylactic acid (PLA), polyhydroxyalkanoates (PHAs) and cellulose. In some embodiments, tray 15 can comprise a substantially gas impermeable plastic layer laminated thereto or any combination of plastic, paper, glass, aluminum or other metal coatings, and/or coextrusions or laminations of such materials. In some embodiments, the materials used to form tray 15 can comprise one or more barrier layers, sealant layers, abuse layers, tie layers, and/or bulk layers. Such layers are well known to those of ordinary skill in the art.

In the case of red meat or other similar products that can include liquids of any type, the material used to construct tray 15 can be comparably dense to prevent seepage of the liquid. Absorbent trays such as those supplied by Vitembal (Avignon, France) or Linpak (Swanton, Ohio, United States of America) can be employed for this purpose. In addition, in some embodiments, tray 15 can comprise a soaker pad to absorb product drip loss and to further prevent or reduce discoloration of product 40. Examples of such absorbent pads are provided in U.S. Pat. No. 5,320,895 to Larsonneur et al. and U.S. Pat. No. 6,278,371 to Hopkins, the entire disclosures of which are incorporated herein by reference.

In some embodiments, tray 15 can have a thickness ranging from about 10 mils to about 25 mils (250 to 625 microns). The thickness of the side walls 35 and end walls 30 can be equal to or less than the thickness of bottom wall 25 of tray 15.

In some embodiments, tray 15 can comprise an easy open feature, such as tab 60, depicted in FIG. 1a. In use, one would merely peel tab 60 to separate film 20 from tray 15 to have direct access to the items contained within package 10. One of ordinary skill in the art would recognize that any of a number of suitable opening means can be included within the presently disclosed subject matter. For example, ring pull tabs, zippers, and the like can be used. See, for example, U.S. Pat. No. 7,419,301 to Schneider et al.; U.S. Pat. No. 7,395,642 to Plourde et al.; U.S. Pat. No. 7,322,920 to Johnson; U.S. Pat. No. 7,261,468 to Schneider et al.; U.S. Pat. No. 6,539,691 to Beer; U.S. Pat. No. 5,121,997 to La Pierre et al.; U.S. Pat. No. 5,100,246 to La Pierre et al.; U.S. Pat. No. 5,077,064 to Hustad et al.; U.S. Pat. No. 5,022,530 to Zieke; U.S. Pat. No. 6,976,588 to Wischusen et al.; U.S. Pat. No. 5,865,335 to Farrell et al.; U.S. Pat. No. 5,332,150 to Poirier; U.S. Pat. No. 4,778,059 to Martin et al.; and U.S. Pat. No. 4,680,340 to Oreglia et al., the entire disclosures of which are incorporated herein by reference.

III.C. Film 20

As depicted in FIGS. 1a and 1b, film 20 can be hermetically sealed to tray 15 along flanges 45 such that package 10 is substantially air and liquid tight (i.e., sealed). Thus, film 20 can be sealed to tray 15 such that package 10 surrounds product 40 on all sides to reliably contain the product in its respective cavity before, during, and after on-demand oxygen generation has been initiated.

In some embodiments, film 20 can be any suitable barrier layer, film, or laminate that is substantially impermeable to gas (such as oxygen). Suitable polymeric materials having gas barrier properties for use in the presently disclosed subject matter include (but are not limited to) ethylene vinyl alcohol copolymers, vinylidene chloride copolymers (PVDC) such as vinylidene chloride vinyl chloride or vinylidene chloride methyl acrylate. Laminates of a sealable film and a barrier structure that includes a barrier layer and a tough, non-forming material such as a biaxially oriented nylon or biaxially oriented polyester can also be used as an impermeable lidding of the present packages. Alternatively or in addition, metal foil or SiOx compounds can be used to provide low oxygen transmission to the tray. Metallized foils can include a sputter coating or other application of a metal layer to a substrate. In some embodiments, oxygen barrier films can have oxygen permeability of less than 500 cm^{3 O}₂/m²·day·atm; in some embodiments, less than 100 cm³ O₂/m²·day·atm; in some embodiments, less than 50 cm³ O₂/m²·day·atm; in some embodiments, less than 25 cm³ O₂/m²·day·atm; in some embodiments, less than 10 cm³ O₂/m²·day·atm; in some embodiments, less than 5 cm³ O₂/m²·day·atm; and in some embodiments, less than 1 cm³ O₂/m²·day·atm (tested at 1 mil thick and at 25° C. in accordance with ASTM D3985).

Alternatively, film 20 can be oxygen permeable in embodiments wherein package 10 is enclosed within a barrier overwrap. In such embodiments, film 20 can comprise oxygen permeable materials, such as (but not limited to) ethylene/vinyl acetate (EVA) and/or ethylene/acrylic acid (EAA). As used herein, the term “oxygen permeable film” refers to a film packaging material that can permit the transfer of oxygen from the exterior of the package to the interior of the package. In some embodiments, oxygen permeable films can have a permeability of greater than about 10,000 cc/m²·day·atm at 73° C. and in some embodiments, greater than about 17,000 cc/m²·day·atm at 73° C.

Thus, film 20 can be provided in sheet or film form and can be any of the films commonly used for the disclosed type of packaging. Accordingly, film 20 can comprise one or more barrier layers, seal layers, tie layers, abuse layers, and/or bulk layers. The polymer components used to fabricate film 20 according to the presently disclosed subject matter can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films. See, for example, U.S. Pat. No. 7,205,040 to Peiffer et al.; U.S. Pat. No. 7,160,378 to Eadie et al.; U.S. Pat. No. 7,160,604 to Ginossatis; U.S. Pat. No. 6,472,081 to Tsai et al.; U.S. Pat. No. 6,222,261 to Horn et al.; U.S. Pat. No. 6,221,470 to Ciacca et al.; U.S. Pat. No. 5,591,520 to Migliorini et al.; and U.S. Pat. No. 5,061,534 to Blemberg et al., the disclosures of which are hereby incorporated by reference in their entireties.

Generally, the films employed in the presently disclosed subject matter can be multilayer or. Typically, however, the films employed will have two or more layers in order to incorporate a variety of properties, such as, for example, sealability, gas impermeability, and toughness into a single film. Thus, in some embodiments, film 20 comprises a total of from about 4 to about 20 layers; in some embodiments, from about 4 to about 12 layers; and in some embodiments, from about 5 to about 9 layers. Accordingly, the disclosed film can comprise 1, 2, 3, 4, 5, 6, 7, 8, 9, 10, 11, 12, 13, 14, 15, 16, 17, 18, 19, or 20 layers.

Film 20 can have any total thickness desired, so long as the film provides the desired properties for the particular packaging operation in which the film is used, e.g., optics, modulus, seal strength, and the like. Final web thicknesses can vary, depending on process, end use application, and the like. Typical thicknesses can range from about 0.1 to 20 mils; in some embodiments, about 0.3 to 15 mils; in some embodiments, about 0.5 to 10 mils; in some embodiments, about 1 to 8 mils; in some embodiments, about 1 to 4 mils; and in some embodiments, about 1 to 2 mils.

In some embodiments, film 20 can be transparent (at least in the non-printed regions) such that product 40 is visible through the films. The term “transparent” as used herein can refer to the ability of a material to transmit incident light with negligible scattering and little absorption, enabling objects (e.g., packaged food or print) to be seen clearly through the material under typical unaided viewing conditions (i.e., the expected use conditions of the material). The transparency of the film can be at least about any of the following values: 20%, 25%, 30%, 40%, 50%, 65%, 70%, 75%, 80%, 85%, and 95%, as measured in accordance with ASTM D1746.

III.D. Vacuum Skin 37

As depicted in FIG. 1c, in some embodiments, package 10 can comprise vacuum skin 37 in addition to film 20. Vacuum skin film 37 is oxygen permeable, such that when oxygen is generated within the cavity of the tray, the oxygen permeates through vacuum skin film 37 to contact product 40. It is important that vacuum skin 37 have certain properties or characteristics. Particularly, vacuum skin 37 should adhere to the tray throughout the manufacturing, fabricating, and packaging processes up until the time it is desired to peel it away. It is thus important that it readily separates from the tray without weakening or tearing. It is therefore significant that vacuum skin 37 has sufficient adherence strength without requiring too high a peel strength for separation.

Vacuum skin 37 can be provided in sheet or film form and can be any of the films commonly used for the disclosed type of packaging. Thus, the permeable film or web used in vacuum skin 37 can be an oxygen permeable or non-barrier film or skin that can be a formable or stretchable material. Typical polymeric materials that can be used in vacuum skin 37 can include any material that can be securely sealed and bonded to the tray, such as (but not limited to) polyethylene or any of a variety of ethylene copolymers including, for example, ethylene vinyl acetate, ethylene acrylate copolymers, ethylene acrylic acid copolymers including metal neutralized salts thereof, and ethylene alpha-olefin copolymers. See, for example, U.S. Pat. No. 3,835618 to Perdue and U.S. Pat. No. 6,042,913 to Miranda et al., the disclosures of which are which are hereby incorporated by reference in their entireties.

In addition, the polymer components used to fabricate vacuum skin 37 according to the presently disclosed subject matter can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films.

Vacuum skin 37 can have any total thickness desired, so long as it provides the desired properties for the particular packaging operation in which it is used. Typical thicknesses can range from about 0.1 to 20 mils; in some embodiments, about 0.3 and 15 mils; in some embodiments, about 0.5 to 10 mils; in some embodiments, about 1 to 8 mils; in some embodiments, about 1 to 4 mils; and in some embodiments, about 1 to 2 mils.

In some embodiments, vacuum skin 37 comprises a total of from about 1 to 20 layers; in some embodiments, from about 4 to about 12 layers; and in some embodiments, from about 5 to about 9 layers. Accordingly, vacuum skin 37 can comprise 1, 2, 3, 4, 5, 6, 7, 8, 9, 10, 11, 12, 13, 14, 15, 16, 17, 18, 19, or 20 layers.

III.E. Oxygen Generating Device 55

IlI.E.i. Generally

On-demand oxygen generation is accomplished by disposing a mass of oxygen generating material on an internal or external surface of an article to ultimately increase the oxygen concentration therein. The oxygen generating material is housed in oxygen generating device 55, which can be a cartridge, pouch, sachet, or other similar container. For applications with fresh red meat, at the time package 10 is ready for display, the oxygen generation can be initiated to increase the oxygen concentration within the package interior, thereby promoting blooming of the meat.

III.E.ii. Peroxides

There are a wide variety of materials that can be disposed within oxygen generating device 55 to generate oxygen. For example, in some embodiments, a peroxide or latent peroxide can be employed. Suitable peroxides can include (but are not limited to) hydrogen peroxide, carbamide peroxide, sodium peroxide, lithium peroxide, calcium peroxide, sodium perborate, potassium, percarbonate, percarbamide, peracetic acid, performic acid, and persulfuric acid.

For example, hydrogen peroxide (H₂O₂) catalytically decomposes exothermically into water (H₂O) and oxygen gas (O₂). The reaction is very favorable thermodynamically (ΔH=−98.2 kJ/mol; ΔG=−119.2 kJ/mol; and ΔS=70.5 kJ/mol-K). The chemical equation of the hydrogen peroxide decomposition reaction is as follows:

H₂O₂→½O₂+H₂O.

The catalytic decomposition of hydrogen peroxide solution is very fast, allowing nearly instantaneous production of oxygen. Suitable catalysts that can be used to decompose hydrogen peroxide to produce oxygen include both inorganic and organic catalysts. For example, suitable organic catalysts can include (but are not limited to) catalase and peroxidase. In addition, the enzyme superoxide dismutase (SOD) can be used. SOD is a class of enzymes that catalyze the dismutation of superoxide into oxygen and hydrogen peroxide. Suitable inorganic catalysts can include (but are not limited to) silver, silver-palladium alloy, manganese dioxide, potassium iodide, cobalt oxide, copper oxide as well as other transition metals and their compounds. Thus, the inorganic catalyst can comprise transition metals and transition metal oxides, as well as halide salts.

In some embodiments, the peroxide can comprise a metal peroxide to generate oxygen within package 10. Particularly, adding water to a metal peroxide produces metal hydroxide and hydrogen peroxide. The hydrogen peroxide then decomposes into oxygen and water. In some embodiments, the decomposition of hydrogen peroxide can be accelerated with the use of a catalyst. In some embodiments, it may be desired to support the catalyst on a surface, such as zeolite, silica, and/or clay. In some embodiments, it may be advantageous to provide a transition metal catalyst in the form of a polymeric ionomer salt.

The chemical equation of a representative metal peroxide (calcium peroxide, CaO₂) and water reaction is as follows:

CaO₂+2H₂O→Ca(OH)₂+H₂O₂ H₂O₂→½O₂+H₂O.

Metal peroxides that can be used in oxygen generating device 55 include (but are not limited to) calcium peroxide, magnesium peroxide, sodium peroxide, lithium peroxide, and potassium peroxide. The water-induced decomposition of a metal peroxide allows sustained oxygen production over a period of several hours or several days and thus is much slower than the hydrogen peroxide catalytical decomposition reactions disclosed above. Accordingly, combinations of different types of reactions (i.e., slow reactions and fast reactions) can provide an initial burst of oxygen followed by continued oxygen production. Such combinations can be beneficial in situations wherein product 40 absorbs or consumes oxygen over time (i.e., such as with red meat).

III.E.iii. Superoxides

In some embodiments, a superoxide can be employed to generate oxygen within oxygen generating device 55. Examples of superoxides suitable for use with the presently disclosed subject matter can include (but are not limited to) sodium superoxide (NaO₂), potassium superoxide (KO₂), calcium superoxide (Ca(O₂)₂), barium superoxide (Ba(O₂)₂), and tetramethylammonium superoxide ((CH₃)₄NO₂). Upon the addition of water, the dissolved O₂⁻¹ ion of the superoxide undergoes disproportionation (dismutation) very quickly to oxygen and hydrogen peroxide, which can then decompose to oxygen and water. For example, the reaction of sodium superoxide and water is as follows:

4NaO₂+4 H₂O→2O₂+2H₂O₂+4NaOH 2H₂O₂→2H₂O+O₂.

III.E.iv. Perborates

In some embodiments, a perborate can be employed to generate oxygen within oxygen generating device 55. Examples of perborates suitable for use with the presently disclosed subject matter can include (but are not limited to) perborate salts of Group I and II metals (i.e., sodium perborate (NaBO₃)). The chemical reaction of sodium perborate and water is as follows:

2Na₂B₂O₈H₄+H₂O→4H₂O₂+2NaOH+Na₂B₄O₇ 2H₂O₂→2H₂O+O₂.

Thus, perborates can generate hydrogen peroxide when contacted with water. These chemistries will also generate alkaline species, and thus the reaction can be further catalyzed by acid or it may be desirable to neutralize the alkalinity. Any of a wide variety of acids can be used, including (but not limited to) acetic acid, citric acid, tartaric acid, fumaric acid, polystyrene sulfonic acid, polyacrylic acid, and combinations thereof.

III.E.v. Percarbonates

In some embodiments, a percarbonate can be used to generate oxygen within the disclosed oxygen generating device. As set forth herein above, “percarbonate” refers to the stable addition compound of hydrogen peroxide with a metal carbonate salt. Percarbonates suitable for use with the presently disclosed subject matter can include (but are not limited to) sodium and potassium percarbonate. When percarbonates are contacted with water, they release hydrogen peroxide, which then disproportionates to oxygen and water. For example, sodium percarbonate (“SPC”) is an inclusion complex of sodium carbonate (Na₂CO₃) and hydrogen peroxide. When SPC comes into contact with water, it releases hydrogen peroxide which decomposes into water and oxygen. The reaction is as follows:

2(Na₂CO₃×1.5H₂O₂)→2Na₂CO₃+3H₂O₂ 2H₂O₂→2H₂O+O₂.

Thus, percarbonates can generate hydrogen peroxide on contact with water. These chemistries will also generate alkaline species, and thus the reaction can be further catalyzed by acid, or it may be desirable to neutralize the alkalinity. Sufficient neutralization of the carbonate formed will generate carbon dioxide (CO₂), which is sometimes included in MAP gases to further extend the shelf life of fresh meats. Any of a wide variety of acids can be used, including (but not limited to) acetic acid, citric acid, tartaric acid, fumaric acid, polystyrene sulfonic acid, polyacrylic acid, and combinations thereof.

III.E.vi. Persulfate Salts of Group I and II Metals

In some embodiments, a persulfate salt of Group I and II metals can be used to generate oxygen within the disclosed oxygen generating device. The persulfate salts of Group I and II metals react with water to form hydrogen peroxide. For example, sodium persulfate (Na₂S₂O₈) reacts with water to form hydrogen peroxide.

III.E.vii. Others

Although several oxygen generating materials have been included herein above, one of ordinary skill in the art would recognize that there are several other oxygen generating materials that can be used as well. For example, sodium hypochlorite (NaOCl) is a compound that reacts with hydrogen peroxide to form oxygen. The reaction is as follows:

NaOCl+H₂O₂→O₂+NaCl+H₂O.

Thus, in some embodiments disclosed oxygen generating materials can include (but are not limited to) two or more components selected from the group comprising: peroxide and catalyst, metal peroxide and water, percarbonate and water, superoxide and water, perborate and water, persulfate salts of Group I and II metals and water, and/or combinations thereof.

III.E.viii. Pouch 65

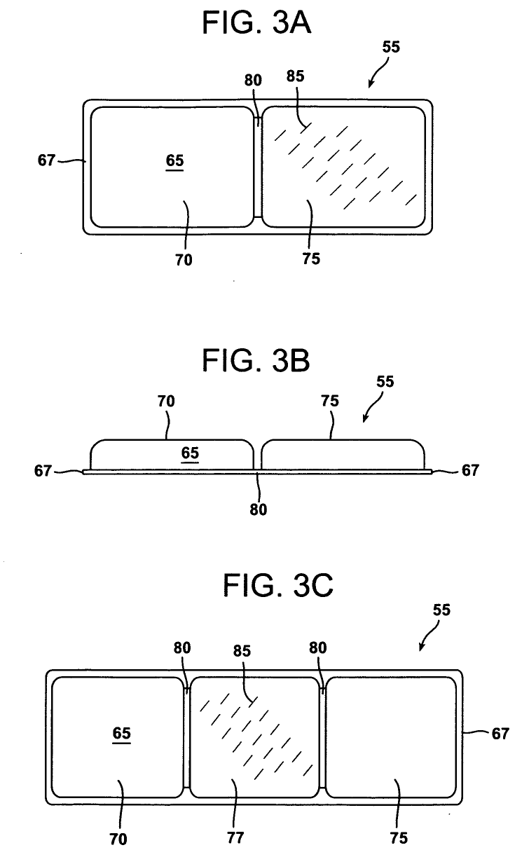

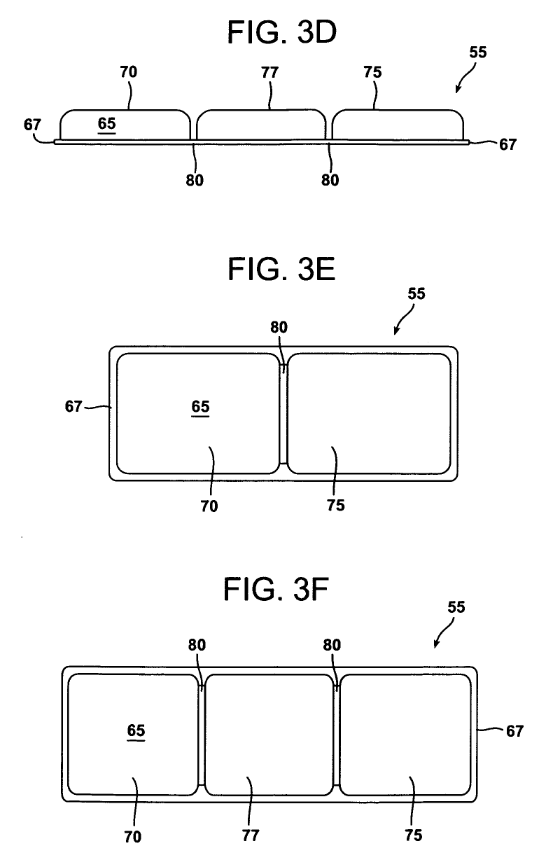

As depicted in FIGS. 3a and 3b, in some embodiments, oxygen generating device 55 can include pouch 65. In some embodiments, the pouch can be constructed from two separate sheets, or alternatively, a single sheet that has been center-folded at one edge. Together the sheets define pouch 65 having a plurality of interior compartments for receiving various components. Particularly, pouch 65 can comprise first compartment 70 that contains a first component of an oxygen generating reaction. Pouch 65 can also comprise second compartment 75 that contains a second component of an oxygen generating reaction. Frangible seal 80 separates the two components in the pouch. As used herein, the term “frangible seal” refers to a seal that is sufficiently durable to allow normal handling of the package but will rupture or substantially rupture under pressure applied by manipulating pouch 65. Thus, as would be apparent to those of ordinary skill in the art, frangible seal 80 can be ruptured by physically manipulating one or both compartments 70, 75 to allow the components of the compartments to intermix. Frangible seals are known to those of ordinary skill in the art. See, for example U.S. Pat. No. 6,983,839 to Bertram et al. and U.S. Patent Application Publication No. 2006/0093765 to Mueller, the entire disclosures of which are incorporated by reference herein.

Alternatively or in addition, the compartments of pouch 65 can be separated by a breakable bubble. Particularly, a bubble containing one component of an oxygen generating reaction can be positioned within a pouch containing a second component of an oxygen generating reaction. At a desired time, a user can exert pressure on the bubble to burst it, allowing the two components of the oxygen generating reaction to intermix. In addition, in some embodiments, the components of pouch 65 can be separated by a peelable seal. Specifically, a pouch can be folded upon itself using a peelable seal to form two compartments. At a desired time, a user can peel the seal to allow the components of the two compartments to intermix.

Pouch 65 can be sealed on all edges by end seal 67 to contain the contents of the pouch. Preferably, each of the edges of end seal 67 are non-frangible and are permanently sealed and will not rupture by the pressures necessary to break frangible seal 80. End seal 67 can be formed using any of a wide variety of methods known in the art, including (but not limited to) adhesive, thermal bonds, ultrasonic bonds, radio frequency sealing, and/or the like.

In some embodiments, perforations 85 can be employed in first and/or second compartments 70, 75 to allow the generated oxygen to flow from the pouch into the interior of package 10. As an alternative or in addition to perforations 85, holes, slits, and the like can be used.

Alternatively, in some embodiments, oxygen generating device 55 can comprise configurations wherein pouch 65 contains three or more compartments. In FIGS. 3c and 3d, for example, pouch 65 comprises first compartment 70 that contains a first component of an oxygen generating reaction and second compartment 75 that contains a second component of an oxygen generating reaction. In addition, in some embodiments, pouch 65 can comprise third compartment 77 positioned between first and second compartments 70, 75. Frangible seal 80 separates first and third compartments 70, 77, as well as second and third compartments 75, 77. In some embodiments, third compartment 77 can optionally contain perforations 85 and can otherwise be empty. In some embodiments, third compartment 77 can comprise one or more additional components that can be reacted to initiate oxygen production. One of ordinary skill in the art would recognize that the three compartments of FIGS. 3c and 3d can be arranged in any order, i.e., 1-2-3, 1-3-2, 3-2-1, 3-1-2, 2-1-3, or 2-3-1, wherein “1” indicates first compartment 70, “2” indicates second compartment 75, and “3” indicates third compartment 77. One of ordinary skill in the art would also recognize that pouch 65 (or any oxygen generating means 55) can contain any number of compartments and is not limited to the embodiments set forth herein.

After a review of the presently disclosed subject matter, one of ordinary skill in the art would recognize that perforations 85 are optional and suitable for embodiments wherein the oxygen generating device is packaged on the interior of package 10. Thus, the oxygen generating devices depicted in FIGS. 3a-3d can be positioned within a tray, bottle, box, or other article. For example, FIGS. 3e and 3f. The oxygen generating devices depicted in FIGS. 3e and 3f do not comprise perforations. Accordingly, these devices are suitable for positioning on an outside surface of a tray, bottle, box, or other article, as illustrated in FIGS. 1a, 2a, and 2b. In these embodiments, the oxygen generating devices comprise a means to allow the generated oxygen to reach the interior of the article, such as container accessing means 110.

III.E.iv. Cartridge 95

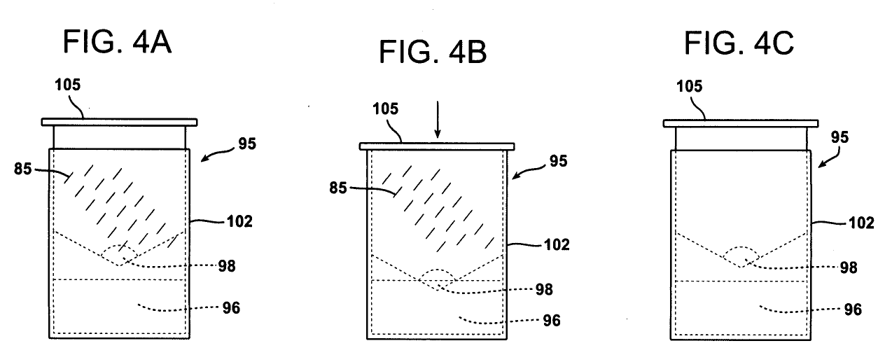

In some embodiments, as illustrated in FIG. 4a, oxygen generating device 55 can comprise cartridge 95. Particularly, cartridge 95 can comprise base 102 comprising first component 96 of an oxygen generating reaction. Cartridge 95 can also comprise moveable means 105 comprising second component 98 of an oxygen generating reaction. As depicted in FIG. 4b, a user can initiate oxygen generation by manually or mechanically applying a downward pressure on moveable means 105 to position it within base 102, thus allowing oxygen generating components 96, 98 to intermix and generate oxygen.

As illustrated in FIGS. 4a and 4b, in some embodiments, base 102 comprises a plurality of perforations 85 to allow the oxygen to flow from cartridge 95 into the interior of package 10. After a review of the presently disclosed subject matter, one of ordinary skill in the art would recognize that perforations 85 are optional and suitable for embodiments wherein the oxygen generating device is packaged on the interior of package 10. For example, FIG. 4c illustrates one embodiment of cartridge 95 that can be positioned on the exterior of an article (i.e., the cartridge does not comprise perforations). In these embodiments, the oxygen generating devices comprise a means to allow the generated oxygen to reach the interior of the article, such as container accessing means 110.

One of ordinary skill in the art would also recognize that cartridge 95 is not limited to the particular configuration illustrated in FIGS. 4a-4c. Rather, cartridge 95 (and oxygen generating device 55) can include any of a wide variety of containers that allow two or more components to intermix on demand.

III.E.v. Location of Oxygen Generating Device 55

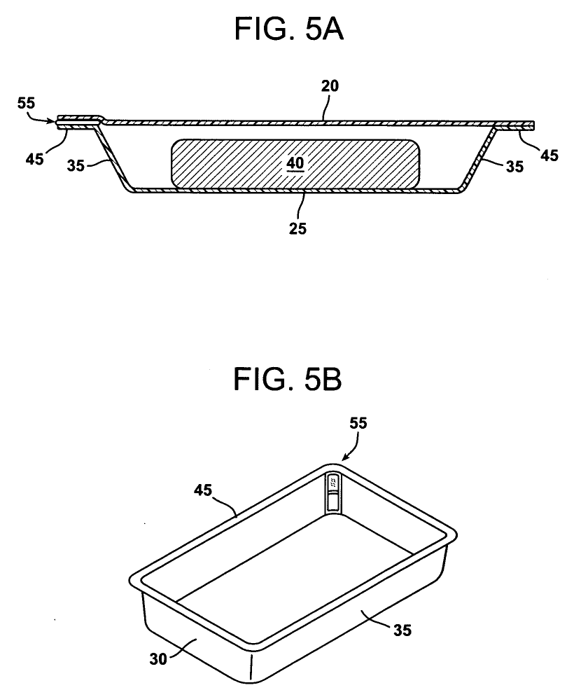

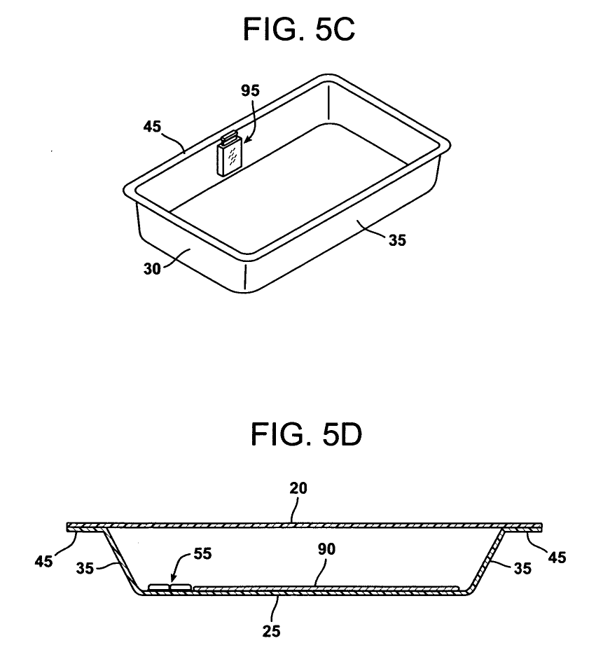

In some embodiments, oxygen generating device 55 can positioned within package 10 (i.e., interior to the package). In such embodiments, first, second, and/or third compartments 70, 75, 77 (or base 102 for cartridge 95) can comprise perforations 85 or other means to allow the generated oxygen to flow into the interior of package 10. For example, FIG. 5a illustrates that oxygen generating device 55 (i.e., pouch 65) can be positioned between flange 45 and film 20 of a tray, such that a user need only apply pressure to the flange at the location of the oxygen generating device to rupture frangible seal 80 and allow the pouch contents to intermix to produce oxygen. Although a pouch is illustrated in FIG. 5a, one of ordinary skill in the art would recognize that any of the wide variety of oxygen generating devices can be employed.

FIG. 5b illustrates that in some embodiments oxygen generating device 55 can be positioned in one corner or on one or more walls of package 10. Thus, a user need only squeeze or initiate the area of the package that contains oxygen generating device 55 to allow the contents to intermix and generate oxygen (i.e., to rupture frangible seal 80 and allow the pouch contents to mix). Although pouch 65 is depicted in FIG. 5b, it is recognized that any of a wide variety of oxygen generating devices can be positioned in one corner or on one or more walls of package 10. For example, FIG. 5c illustrates that cartridge 95 can also be used. In the embodiment depicted in FIG. 5c, a user can manipulate moveable means 105 through film 20 to initiate the oxygen generating reaction.

FIG. 5d illustrates that in some embodiments oxygen generating device 55 can be incorporated within or positioned adjacent to absorbent pad 90. In such embodiments, a user need only apply pressure to the bottom face of package 10 to initiate oxygen production (for example, to rupture frangible seal 80 and allow the pouch contents to intermix). Although pouch 65 is depicted in FIG. 5d, it is recognized that any of a wide variety of oxygen generating devices can be used.

Thus, although several embodiments are depicted in FIGS. 5a-5d, one of ordinary skill in the art would recognize that oxygen generating device 55 can be positioned at any of a wide variety of locations within the interior of package 10. For example, oxygen generating device 55 can be positioned on a side wall, end wall, between a side wall and end wall, on a flange, on a ledge or other support means, between a flange and film 20, on bottom wall 25, between bottom wall 20 and a side or end wall, within or adjacent to an absorbent pad, and the like.

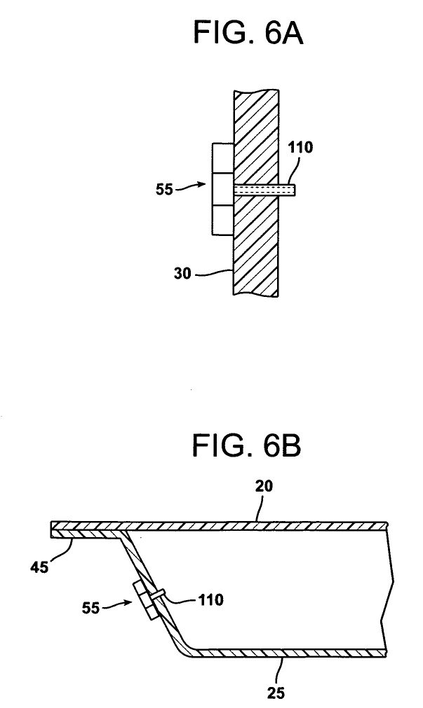

However, in some embodiments, oxygen generating device 55 can be positioned on an exterior surface of a container. Particularly, in some embodiments, oxygen generating device 55 can comprise accessing means 110 to allow the generated oxygen to enter the interior of an article. For example, in some embodiments accessing means 110 can comprise an open tube that penetrates a wall of the package. FIGS. 6a and 6b illustrate one embodiment of accessing means 110. Particularly, accessing means 110 can be positioned on an external surface of an article to penetrate a wall (e.g., side wall 30 of a tray) to allow oxygen to flow from oxygen generating means 55 into the interior of a package. Oxygen generating device 55 can be positioned interior or exterior to package 10 using any of a wide variety of means known in the art. For example, adhesives, metal clips, or other similar devices can be used.

III.F. Packaged Product 40

Products that can be packaged using the disclosed system and method can include (but are not limited to) food products such as meat, vegetables, fruit, pasta, and the like. In addition, non-food items including (but not limited to) photographic film, computer components, inorganic materials susceptible to oxidation, and the like can be used with the disclosed packaging system.

Examples of food products that are suitable for use with the presently disclosed subject matter include, but are not limited to, meat such as beef, birds such as poultry (including chicken, duck, goose, turkey, and the like), buffalo, camel, dog, game (including deer, eland, antelope, and the like), game birds (such as pigeon, quail, doves, and the like), goat, hare, horse, kangaroo, lamb, marine mammals (including whales and the like), amphibians (including frogs and the like), monkey, pig, rabbit, reptiles (including turtles, snakes, alligators, and the like), and/or sheep. One of ordinary skill in the art would readily recognize that the above list is not exhaustive and can include any of a variety of meat products.

Further, non-food items suitable for use with the presently disclosed subject matter can include, but are not limited to, pharmaceuticals, photographic film, computer components, inorganic materials susceptible to oxidation, electronics, biological systems, and the like. One of ordinary skill in the art would readily recognize that the above list is not exhaustive and can include any of a variety of non-food items.

### IV. Manufacture of the Disclosed Package

IV.A. Generally

The presently disclosed subject matter is directed to a package comprising a product to be initially stored until a higher oxygen concentration environment is desired. In some embodiments, package 10 is suitable for display at a retail establishment for purchase by a consumer. Thus, package 10 can be produced at a central processing facility for subsequent distribution to retail outlets (such as butcher shops, grocery stores, and the like). To this end, in some embodiments, package 10 can contain a case-ready meat product comprising fresh meat. Case-ready meat products can be generally defined as fresh meat that is pre-packaged and optionally pre-labeled at a centralized location and delivered to the retail market prepared for final sale.

In some embodiments, package 10 can be a modified atmosphere package (“MAP”), wherein product 40 is maintained in a sealed container containing a headspace with an atmosphere that is different than ambient air. Particularly, in MAP packaging, a product is generally packaged in a tray having a peripheral flange to which a lidding film is secured. Prior to securing the film to the tray, air is evacuated from the interior of the tray and replaced by a gas that differs from ambient air. For example, fresh meat and other food products can be packaged in a low-oxygen environment (e.g, high levels of carbon dioxide and/or nitrogen) after evacuating all or most of the air from the package. Such MAP systems are well known to those of ordinary skill in the art. Examples of such MAP packaging are disclosed in U.S. Pat. No. 5,686,126 to Noel et al. and U.S. Pat. No. 5,779,050 to Kocher et al., the entire disclosures of which are hereby incorporated by reference.

Thus, in some embodiments, the oxygen level within package 10 can be reduced to a first level in the range less than 0.5% and preferably less than 0.05%. The reduction in oxygen level can be accomplished using one or more techniques, including but not limited to, evacuation, gas flushing, and/or oxygen scavenging. Such methods are well known to those of ordinary skill in the packaging art. For example, during a gas flushing process, an appropriate mixture of gases is introduced into the cavity of package 10 to create a modified atmosphere therein.

Package 10 is then sealed to provide an airtight, sealed container containing a low-oxygen atmosphere. For example, when product 40 comprises a red meat product, the cut of meat within the modified atmosphere package takes on a purple-red color when the oxygen is removed from the interior of package 10. The modified package can then be stored in a refrigeration unit for several weeks prior to being offered for sale at a retail establishment. It should be noted that the presently disclosed subject matter comprises embodiments wherein package 10 is not a modified atmosphere package and the interior of the article comprises ambient air.

Once oxygen generating device 55 is initiated, oxygen permeates into the interior of package 10. In some embodiments, the oxygen level within the interior of package 10 can be increased to a level in the range of from about 1% to 80%; in some embodiments, from about 10% to 40%; and in some embodiments, from about 15% to 30%. The purple-red color of the meat then changes (or “blooms”) to a generally acceptable bright red color when the meat is oxygenated.

IV.B. Package 10

In some embodiments, package 10 can be fabricated from a sheet or web that is thermoformed to produce an article of desired shape. Thermoforming is well known in the packaging art, and is the process whereby a thermoplastic web is heat softened and reshaped to conform to the shape of a cavity in a mold. Suitable thermoforming methods, for example, include a vacuum forming or plug-assist vacuum forming method. In a vacuum forming method, the first web is heated, for example, by a contact heater, and a vacuum is applied beneath the web causing the web to be pushed by atmospheric pressure down into a pre-formed mold. In a plug-assist vacuum forming method, after the first or forming web has been heated and sealed across a mold cavity, a plug shape similar to the mold shape impinges on the forming web and, upon the application of vacuum, the forming web transfers to the mold surface.

Thus, in some embodiments, the thermoformable web suitable to manufacture package 10 can be manufactured by thermoplastic film-forming processes known in the art. Accordingly, in some embodiments, the film can be prepared by extrusion or coextrusion utilizing, for example, a tubular trapped bubble film process or a flat film (i.e., cast film or slit die) process. In some embodiments, the thermoformable film can be prepared by applying one or more layers by extrusion coating, adhesive lamination, extrusion lamination, solvent-borne coating, and/or by latex coating (e.g., spread out and dried on a substrate). A combination of these processes can also be employed. These processes are known to those of ordinary skill in the art.

The thermoformable web generally comprises materials conventionally used in thermoforming, such as (but not limited to) polyvinyl chloride, polyester, copolyester, high impact polystyrene, polystyrene, polypropylene, copolymers of polypropylene, high density polyethylene, polybutylene terephthalate, styrene-butadiene copolymers, polyacrylonitrile copolymers, polycarbonate, polymethylmethacrylate, polyethylene terphthalate (PET), crystalline polyethylene terphthalate (CPET), amorphous polyethylene terephthalate (APET), polyamides (Nylons), polylactic acid (PLA), polyhydroxyalkanoates (PHAs) and blends or composites of the above materials including blends with other various polymeric, organic, or inorganic materials as are known to those skilled in the art.

While some thermoformable webs can retain flexibility after being shaped, certain webs can also have sufficient rigidity after being formed to serve as packing trays. Examples of such trays and peelable film lids are disclosed in U.S. Pat. No. 4,810,541 to Newman et al., which is hereby incorporated in its entirety.

One of ordinary skill in the art would also recognize that in embodiments wherein package 10 comprises bottles, boxes, or other such materials, such articles can be constructed using a wide variety of materials and methods known to those of ordinary skill in the art.

IV.C. Film 20

Product 40 can be packaged using any of a variety of methods known to those of ordinary skill in the art. For example, product 40 can be manually or mechanically placed on bottom wall 25 of tray 15. Film 20 can then be sealed to tray 15 to enclose product 40 therein. In some embodiments film 20 can be sealed to package 10 at flanges 45. Thus, package 10 can be sealed on all edges using conventional means (i.e., adhesive, heat sealing, and the like). In some embodiments, the sealing operation can occur at the food packaging plant using a heat sealing machine designed for high speed operation. Heat sealing can occur by any of a number of techniques well known in the art, such as but not limited to, thermal conductance heat sealing, impulse sealing, ultrasonic sealing, dielectric sealing, and/or combinations thereof.

In some embodiments, film 20 can be a monolayer structure or a multilayered structure having various layers that are produced by any suitable process known to those of ordinary skill in the art, including (but not limited to) coextrusion, lamination, extrusion coating, and combinations thereof. See, for example, U.S. Pat. No. 6,769,227 to Mumpower, the content of which is incorporated by reference herein in its entirety. Thus, in some embodiments, film 20 can be coextruded or laminated and can be adhered together with a coextruded tie layer. The typical film-to-film bond from lamination can be made by adhering the films together with a thin layer of polyurethane coating on an adhesive laminator. The lamination can also be accomplished by extrusion lamination or extrusion coating with an adhesive coextrusion tie layer type resin at the bond interface. In some embodiments, at least a portion of film 20 can be irradiated to induce crosslinking. In the irradiation process, the film is subjected to one or more energetic radiation treatments, such as corona discharge, plasma, flame, ultraviolet, X-ray, gamma ray, beta ray, and high energy electron treatment, each of which induces cross-linking between molecules of the irradiated material. The irradiation of polymeric films is disclosed in U.S. Pat. No. 4,064,296, to Bornstein et al., which is hereby incorporated by reference in its entirety.

IV.D. Vacuum Skin 37

As illustrated in FIG. 1c, in some embodiments, vacuum skin 37 is formed around product 40 within tray 15 by vacuum or differential air pressure such that the product is packaged under vacuum. Vacuum skin packaging is well known in the packaging art. See, for example, U.S. Pat. No. 6,042,913 to Miranda et al.; U.S. Pat. No. 5,979,653 to Owens et al.; U.S. Pat. No. 5,770,287 to Miranda et al.; U.S. Pat. Nos. 5,346,735; 5,087,462 to Bekele et al.; U.S. Pat. No. 5,076,436 to Bortolani et al.; U.S. Pat. No. 5,048,268 to Brembilla et al.; U.S. Pat. No. 4,812,320 to Ruzek; and U.S. Pat. No. 4,611,456 to Gillio-tos et al., the entire disclosures of which are incorporated by reference herein.

IV.E. Oxygen Generating Device 55

Oxygen generating device 55 is not limited and can encompass any of a wide variety of devices that separate two or more components until it is desired to combine them. For example, as set forth in more detail herein above, oxygen generating device 55 can comprise pouch 65, having multiple compartments separated by a barrier. Alternatively, oxygen generating device 55 can comprise a cartridge that allows a user to manually interact one reaction component with another.

Accordingly, oxygen generating device 55 can be constructed of any of a wide variety of materials, including but not limited to, plastic, wood, paper, metal, and combinations thereof using methods well known in the art. The dimensions of oxygen generating device 55 are also not limited, and can be dictated by the dimensions of package 10.

### V. Methods of Using the Disclosed Package

As discussed herein above, package 10 can be shipped to a retail distributor in the embodiment depicted in FIG. 1a. Particularly, product 40 can be packaged within the interior of tray 15 (or any of a variety of containers). In some embodiments, the package is a modified atmosphere package, wherein the interior of the package has a low-oxygen environment compared to ambient air.

At any desired time (such as, for example, at the time of package display) oxygen generating device 55 is initiated and to generate oxygen and increase the oxygen concentration within the interior of the tray. Particularly, when a pouch of the type disclosed in FIG. 3a is used, frangible seal 80 is manually or mechanically ruptured to allow the two or more oxygen generating components to be intermixed. Alternatively, in some embodiments, when a cartridge of the type disclosed in FIGS. 4a and 4b are used, a user can manually or mechanically depress moveable means 105 to initiate the oxygen generating reaction. In the case of red meat products, for example, upon exposure to the increased oxygen concentration, the red meat will bloom to a red color, which is pleasing to consumers.

In some embodiments, the oxygen generating components can be hydrogen peroxide and a catalyst and/or a metal oxide and water. However, the oxygen generating components are not so limited and can include the wide variety of materials that can be combined to produce oxygen, as set forth in more detail herein above. Combinations of different types of reactions (i.e., slow oxygen production and fast oxygen production) can provide an initial burst of oxygen followed by continued oxygen production. Such combinations can be beneficial in situations wherein product 40 absorbs or consumes oxygen over time (i.e., such as with red meat).

The temperatures at which the disclosed oxygen generating reactions can occur are not limited. Rather, the noted components can be intermixed to produce oxygen at a wide range of temperatures including freezing temperatures, refrigerated temperatures, room temperatures, and heated temperatures. Particularly, in some embodiments freezing temperatures can range from about 0° C. (32° F.) to about −50° C. (−58° F.). In some embodiments, refrigerated temperature can range from about 1° C. (33° F.) to about 10° C. (50° F.). In some embodiments, room temperature can range from about 11° C. (52° F.) to about 32° C. (90° F.). In some embodiments, heated temperatures can range from about 33° C. (91° F.) to about 120° C. (248° F.).

In some embodiments, after oxygen generation, the concentration of oxygen within the package is about 1% to 80%; in some embodiments, from about 10% to 40%; and in some embodiments, from about 15% to 30%. To this end, in some embodiments, the two or more components of the oxygen generating device are capable of generating oxygen at a particular rate and volume in a predetermined proportion to the type and mass of product packaged.

### VI. Advantages of the Disclosed Package and System

The disclosed package and system teaches the on-demand generation of oxygen within a package. Thus, users simply rupture a frangible seal, initiate a pushable means, or the like to allow two or more components housed within an oxygen generating device to react and generate oxygen within the interior of a package. Accordingly, the disclosed package and methods are relatively easy and simple to use, compared to the package and methods of the prior art.

The presently disclosed subject matter also provides direct control over the oxygen level that is produced within a package by controlling the amount of oxygen generating material housed within oxygen generating device 55. For example, incorporating larger amounts of oxygen generating materials within the device will allow for a correspondingly larger amount of oxygen to be produced.

In addition, the oxygen generation of the disclosed package and method can be almost instantaneous, compared to prior art packaging that relies on the slow permeation of oxygen through a film. Also, prior art packaging materials (such as peelable lids) equilibrate to atmospheric oxygen conditions, without any control over the final oxygen level in the package. The disclosed package thus allows for the ability to control the final oxygen level, as well as the combination of fast and slow oxygen generating materials, provides additional benefits for lengthening the shelf life and improving the appearance and quality of a packaged product (such as, for example, red meat).

Continuing, the disclosed package and methods utilize less waste compared to prior art systems. Specifically, prior art package designs utilize peelable lids or require that a barrier film material covering a permeable patch be removed. Such methods generate strips of waste material at the time of display. In addition, the previous package designs require additional labor at the time of display to remove the barrier films or strips. The current package and method, in comparison, allows for the simple pressure of a push or other similar means to initiate conditions for oxygen generation within a package.

Although several advantages of the disclosed system are set forth in detail herein, the list is by no means limiting. Particularly, one of ordinary skill in the art would recognize that there can be several advantages to the disclosed system that are not included herein.

### EXAMPLES

The following Examples provide illustrative embodiments of the presently disclosed subject matter. In light of the present disclosure and the general level of skill in the art, those of ordinary skill will appreciate that the following Examples are intended to be exemplary only and that numerous changes, modification, and alterations can be employed without departing from the scope of the disclosed subject matter.

### Example 1

### Manufacture of Case Ready Packages

A CS975 Cryovac® solid barrier polypropylene tray (available from Sealed Air Corporation, Duncan, S.C., United States of America) was sealed with Cryovac® Lid 1050 Barrier Lidstock (available from Sealed Air Corporation, Duncan, S.C., United States of America) using a Mondini E340 Seal Machine (available from G. Mondini, S.P.A., Brescia, Italy) at a sealing temperature of 135° C. and a sealing time of 0.05 seconds.

### Example 2

### Determination of the Oxygen Concentration in Tray Headspace

Two case ready trays of the type disclosed in Example 1 were prepared. One case ready tray contained a small beaker containing about 1 mg of manganese dioxide (MnO₂), and a wooden block with a volume of about 500 cc to simulate a volume of meat packaged within the tray. The second case ready tray contained a small beaker with about 1 mg of manganese dioxide (MnO₂), but was otherwise empty.

As set forth in Table 1, specific volumes of 30 wt % hydrogen peroxide in water were injected using a syringe (G20). The needle of the syringe was positioned through the lidding film of the case ready trays to inject the hydrogen peroxide solutions into the catalyst (MnO₂) to initiate oxygen generation. The perforation in the lidding film caused by the syringe needle was immediately sealed with barrier tape.

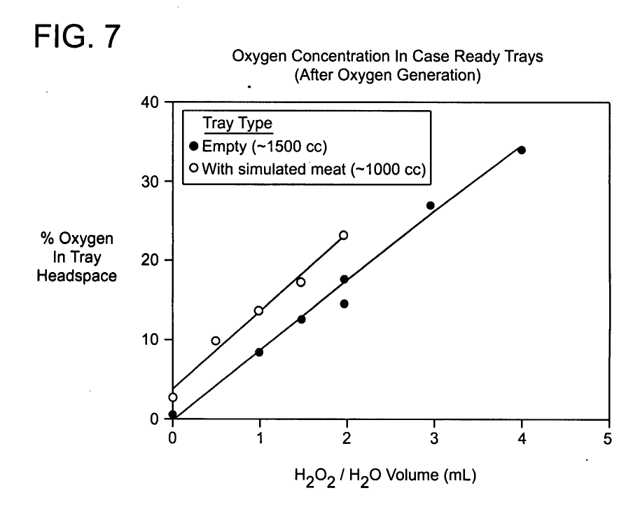

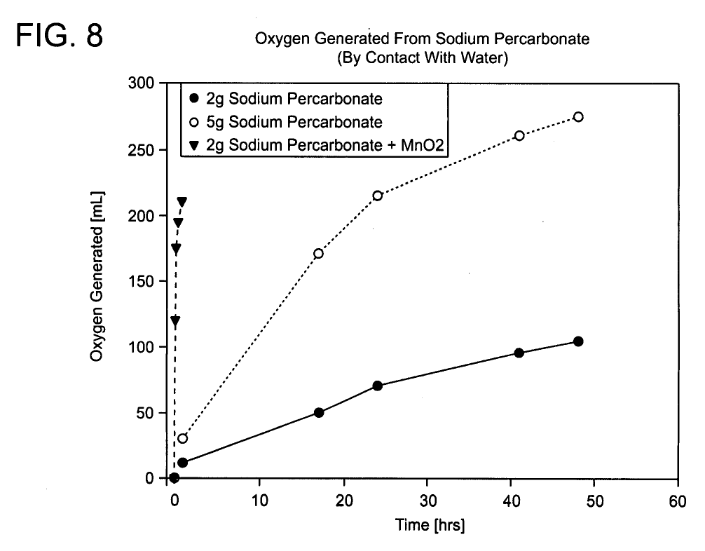

Oxygen generation in the tray headspaces was monitored using a Mocon Dual Headspace Analyzer (Model Number 650, available from Mocon®, Minneapolis, Minn., United States of America). The oxygen generation data is given in Table 1 and is depicted graphically in FIG. 7.

From the data, it was observed that high oxygen concentrations can be readily generated within a package using very small volumes of hydrogen peroxide solution. Reaction initiation is instantaneous using a catalyst and the oxygen generation is rapid.

TABLE 1
Time points

| | % Oxygen in Tray 1 | % Oxygen in Tray 2 |
|---|---|---|
| 30% H₂O₂ Volume (ml) | (Empty) | (With Simulated Meat) |
| 0 | 0.5 | 2.5 |
| 0.5 | — | 9.7 |
| 1.0 | 8.25 | 13.5 |
| 1.5 | 12.5 | 17.1 |
| 2.0 | 14.5 | 23.1 |
| 2.0 | 17.5 | — |
| 3.0 | 27.1 | — |
| 3.0 | 26.9 | — |
| 4.0 | 34.0 | — |

### Example 3

### Time Course of Oxygen Generated After Hydrogen Peroxide Injection

About 250 grams of steak was packaged in a case ready tray of the type disclosed in Example 1. The steak was packaged in a low oxygen environment (4:1 nitrogen:carbon dioxide mixture, with oxygen concentration of less than 0.05%) and thus was purple in color.

About 1 mL of hydrogen peroxide was injected as in Example 2 through the lidding film into the interior of the tray to raise the oxygen level within the tray to about 12.7% and initiate blooming of the meat. The perforation in the lidding film caused by the syringe needle was immediately sealed with barrier tape.

As soon as the hydrogen peroxide was injected, it was observed that the steak was purple in color. However, after 10 minutes had passed, the steak began to bloom to a red color. After 25 minutes, the steak had fully bloomed to a bright red color.

### Example 4

### Oxygen Generation from Hydrogen Peroxide and Catalyst

The rate of oxygen gas produced and practical yield of the oxygen generation from hydrogen peroxide (H₂O₂) and manganese dioxide (MnO₂) catalyst was determined from the reaction:

H₂O₂+MnO₂(catalyst)→H₂O+½O₂

A 50 mL burette filled to an arbitrary level with water was suspended over a beaker of water to create a water column. About 1 mg of MnO₂ catalyst was sealed in a glass round-bottom flask containing a stir bar. A stainless steel double sided needle was run from the flask to the bottom of the water column. About 10 ml of 30 wt % H₂O₂ in water was added to the MnO₂, and oxygen was allowed to evolve. Readings were then taken from the burette over time. After injection of the H₂O₂ solution, oxygen gas was immediately generated and rapidly displaced about 80 mL of water in the cylinder within the first two minutes.

Accordingly, it was determined that high oxygen concentrations can be readily generated using very small volumes of hydrogen peroxide solution and catalytic amounts of MnO₂. Reaction initiation was instantaneous using a catalyst and the oxygen generation is rapid.

### Example 5

### Oxygen Generation from Calcium Peroxide and Water

The rate of oxygen gas produced and practical yield of oxygen generated from the reaction of calcium peroxide (CaO₂) and water (H₂O) was determined from the reaction:

CaO₂+H₂O→Ca(OH)₂+H₂O₂ H₂O₂→½O₂+H₂O

A 50 mL burette was filled to an arbitrary level with water. The burette was suspended over a beaker of water to create a water column. About 2 g of 75% CaO₂ in water was sealed in a glass round-bottom flask containing a stir bar. A stainless steel double-sided needle was run from the flask to the bottom of the water column. An excess of water (3 mL) was added to the CaO₂, and oxygen was allowed to evolve. Readings were then taken from the burette over time.

Oxygen bubbles were observed almost immediately, but the process was very slow. About 5 mL of O₂ was generated after 10 minutes. About 10 mL O₂ was generated after 30 minutes. About 15 mL O₂ was generated after 2 hours. The experiment was left overnight (approximately 16 hours) and about 25 mL of O₂ was generated.

Thus, the metal oxide reaction in the absence of catalyst proceeded very slowly.

### Example 6

### Rate of SPC-Induced Oxygen Generation

Sodium percarbonate (SPC) is an inclusion complex of sodium carbonate and hydrogen peroxide (Na₂CO₃×1.5 H₂O₂). SPC is very storage stable if dry, but releases hydrogen peroxide when in contact with water. The hydrogen peroxide can then slowly decompose to generate oxygen. The decomposition of hydrogen peroxide can be accelerated through the use of a catalyst. The reaction is as follows:

2(Na₂CO₃×1.5 H₂O₂)+H₂O(excess)→2Na₂CO₃+3H₂O+1.5O₂.

Thus, 2 moles of SPC have the capacity to generate 1.5 moles (33.6L) of oxygen.

Three volumetric cylinders filled to an arbitrary level with water were each suspended over a beaker of water to create a water column. 0.0127 moles of SPC were added to each flask and sealed with rubber septums. Varying amounts of catalyst (MnO₂) were added to each flask, as set forth in Table 2. Tubing was then run from each flask to the bottom of a corresponding water column. Varying amounts of water (as set forth in Table 2) were added to the SPC and the amount of oxygen generated was measured at various timepoints. The amount of oxygen generated is set forth in Table 2.

FIG. 8 is a graphical representation of the data from Table 2. Particularly, FIG. 8 is a line graph illustrating a time course of the oxygen generated by 2 g SPC (•), 5 g SPC (∘), and 2 g SPC+MnO₂ (▾).

From the data, SPC can be used in an oxygen generating device for rapid oxygen production for quick meat blooming (with the use of a catalyst and/or for slow generation of oxygen) to sustain the desired oxygen concentration in a tray. From Table 2, it was determined that generating about 200 cc of oxygen in a tray of the type of Example 1 brings the oxygen concentration in a tray to about 30%, which is sufficient for efficient meat blooming. The same amount of oxygen can be generated quickly from about 2 g of SPC with the use of a catalyst.

TABLE 2
Amount of Oxygen Generated Using SPC

| | Amt | Amt | Vol. H₂O | Time point | Amt O₂ |
|---|---|---|---|---|---|
| Expt. | SPC (g) | MnO₂ (mg) | (mL) | (hr) | (mL) |
| 1 | 2 | 0 | 4 | 0 | 0 |
| | | | | 1 | 12 |
| | | | | 17 | 50 |
| | | | | 24 | 70 |
| | | | | 41 | 95 |
| | | | | 48 | 104 |
| 2 | 5 | 0 | 10 | 0 | 0 |
| | | | | 1 | 30 |
| | | | | 17 | 170 |
| | | | | 24 | 214 |
| | | | | 41 | 260 |
| | | | | 48 | 274 |
| 3 | 2 | 1 | 4 | 0 | 0 |
| | | | | 0.1 | 120 |
| | | | | 0.25 | 175 |
| | | | | 0.5 | 195 |
| | | | | 1.0 | 210 |

### Example 7

### Generating Oxygen in Case Ready Trays

29 case ready trays with an interior volume of about 1500 cc were produced as in Example 1. Beakers containing varying amounts of calcium peroxide and catalyst (MnO₂) (as indicated in Table 3) were placed inside the tray and the trays were sealed as in Example 1. To simulate a filled tray, wooden blocks with a volume of about 500 cc were added to trays 7, 8, 9, 14, and 15; wooden blocks with a volume of about 500 cc and one 4×6 in. paper towel were added to trays 25 and 27; and one 4×6 in. paper towel was added to tray 26 prior to sealing.

Oxygen was generated in the trays by injecting water or peroxide into the tray as indicated in Table 3 using a syringe (G20). The hole in the lidding film created by the syringe was immediately sealed using barrier tape. The amount of oxygen and CO₂ was measured using a Mocon Dual Headspace Analyzer (Model No. 650) at the time of injection, 3 hours after injection, 24 hours after injection, and 48 hours after injection. Data is given below in Table 3.

It was initially noted that Package 12 leaked, and thus no data was collected. In addition, data was not collected for the early timepoints of package 19 because the tray was initially believed to leak.

From the data, it was determined that oxygen is generated quickly when catalyst is used. When calcium peroxide is used without catalyst, oxygen generation is slower. Thus, oxygen generation can be controlled readily by adjusting the amount of peroxide contained in the tray. Further, a combination of the CaO₂ and H₂O₂ solution can be employed to generate an initial burst of oxygen followed by slow generation over time.

TABLE 3
Oxygen Generation at 0, 3, 24, and 48 Hours

| | | | | | Inj. | % O₂ | % CO₂ | | % CO₂ | % O₂ | % CO₂ | % O₂ | % CO₂ |
|---|---|---|---|---|---|---|---|---|---|---|---|---|---|
| | MnO₂ | CaO₂ | Init. | Init. | amt. | after | after | % O₂ | at t = | at | at | at | at |
| ID | (mg) | (g) | % O₂ | % CO₂ | (mL) | Inj. | Inj. | at t = 3 hrs | 3 hrs | t = 24 hrs | t = 24 hrs | t = 48 hrs | t = 48 hrs |
| 1 | 1 | 2 | 3.25 | 18.1 | 3, H₂O | 3.24 | 18.1 | 4.98 | 16 | 6.78 | 13.5 | 8.18 | 11.6 |
| 2 | 0 | 2 | 0.39 | 22.2 | 4, H₂O | 0.394 | 22.1 | 1 | 21.5 | 4.8 | 15 | 7.79 | 10.2 |
| 3 | 1 | 3 | 3.78 | 17.4 | 10, 3% | 5.15 | 17.1 | 13.5 | 14.8 | 14.5 | 13.4 | 16.2 | 11 |
| | | | | | H₂O₂ | | | | | | | | |
| 4 | 0 | 3 | 3.61 | 17.6 | 10, 3% | 3.61 | 17.6 | 12.9 | 14.8 | 14.1 | 13.4 | 15.4 | 11.6 |
| | | | | | H₂O₂ | | | | | | | | |
| 5 | 1 | 5 | 3.55 | 17.4 | 5, H₂O | 3.56 | 17.6 | 5.39 | 15.7 | 12.2 | 5.5 | 15.3 | 0.1 |
| 6 | 0 | 5 | 0.638 | 21.5 | 5, H₂O | 0.636 | 21.5 | 2.18 | 18.9 | 12.5 | 1.6 | 13.8 | 0 |
| 7 | 1 | | 2.98 | 18.7 | 1, 30% | 13.5 | 16.7 | 12.4 | 17.1 | 12.4 | 17 | 12.4 | 17 |
| | | | | | H₂O₂ | | | | | | | | |
| 8 | 1 | | 2.96 | 18.8 | 1.5, | 17.1 | 16 | 15.7 | 16.4 | 15.7 | 16.3 | 15.7 | 16.3 |
| | | | | | 30% | | | | | | | | |
| | | | | | H₂O₂ | | | | | | | | |
| 9 | 1 | | 3.07 | 18.7 | 2, 30% | 23.1 | 15 | 20 | 15.8 | 19.9 | 15.6 | 19.9 | 15 |
| | | | | | H₂O₂ | | | | | | | | |
| 10 | 1 | | 0.261 | 22.7 | 1, 30% | 8.23 | 20.9 | 8.29 | 20.8 | 8.37 | 20.8 | 8.38 | 20.5 |
| | | | | | H₂O₂ | | | | | | | | |
| 11 | 1 | | 0.259 | 23 | 2, 30% | 14.6 | 19.5 | 14.7 | 19.2 | 14.7 | 19.1 | 14.7 | 19 |
| | | | | | H₂O₂ | | | | | | | | |
| 12 | 1 | — | — | — | — | — | — | — | — | — | — | — | — |
| 13 | 1 | | 0.245 | 22.6 | 1.5, | 12.5 | 20.1 | 12.7 | 19.5 | 12.8 | 19.7 | 12.9 | 19.4 |
| | | | | | 30% | | | | | | | | |
| | | | | | H₂O₂ | | | | | | | | |
| 14 | 1 | | 2.73 | 19.4 | 0.5, | 9.68 | 18 | 9.32 | 18.1 | 9.36 | 18.1 | 9.35 | 17.8 |
| | | | | | 30% | | | | | | | | |
| | | | | | H₂O₂ | | | | | | | | |
| 15 | 1 | 3 | 4.82 | 16.3 | 1, 30% | 22.6 | 13.4 | 27.4 | 1.6 | 28.5 | 0.1 | 28.8 | 0.1 |
| | | | | | H₂O₂ | | | | | | | | |
| 16 | 0 | 3 | 0.426 | 22.0 | 1, 30% | 0.46 | 22 | 21.6 | 0.3 | 22.4 | 0 | 22.6 | 0 |
| | | | | | H₂O₂ | | | | | | | | |
| 17 | 1 | 5 | 0.76 | 21.2 | 5, H₂O | 1.01 | 21 | 3.53 | 17.1 | 13.5 | 3.1 | 15.7 | 0 |
| 18 | 0 | 5 | 0.755 | 21.4 | 5, H₂O | 0.788 | 21 | 3.44 | 16.6 | 12.5 | 4 | 15.3 | 0 |
| 19 | 1 | — | — | — | — | — | — | — | — | — | — | 17.9 | 7.4 |
| 20 | 1 | | 0.45 | 22.2 | 3, 30% | 27.1 | 16.9 | 26.6 | 14.8 | 26.2 | 14.0 | 25 | 11.8 |
| | | | | | H₂O₂ | | | | | | | | |
| 23 | 1 | | 0.497 | 22.5 | 2, 30% | 17.5 | 18.7 | 20.3 | 17.9 | 20.4 | 17.9 | 20.4 | 17.8 |
| | | | | | H₂O₂ | | | | | | | | |
| 24 | 1 | | 4.49 | 17.5 | 1, 30% | 13.9 | 15.7 | 15.7 | 15.5 | 15.8 | 15.4 | 15.8 | 15.6 |
| | | | | | H₂O₂ | | | | | | | | |
| 25 | 1 | | 3.72 | 17.8 | 2, 30% | 25.3 | 14.2 | 22.8 | 14.7 | 23.6 | 14.6 | 24 | 14.6 |
| | | | | | H₂O₂ | | | | | | | | |
| 26 | 1 | | 0.437 | 22.4 | 4, 30% | 24.7 | 17.2 | 28.6 | 16.1 | 30.4 | 15.4 | 31.3 | 15.4 |
| | | | | | H₂O₂ | | | | | | | | |
| 27 | 1 | | 3.61 | 17.9 | 1.5, | 3.6 | 18.1 | 8.56 | 16.8 | 9.27 | 16.6 | 14.9 | 15.3 |
| | | | | | 30% | | | | | | | | |
| | | | | | H₂O₂ | | | | | | | | |
| 28 | 1 | | 0.355 | 22.5 | 2.5, | 23.2 | 17.4 | 24.4 | 17.1 | 24.7 | 17 | 24.8 | 16.8 |
| | | | | | 30% | | | | | | | | |
| | | | | | H₂O₂ | | | | | | | | |
| 29 | 1 | | 0.458 | 22.3 | 1, 30% | 11.3 | 20.1 | 12.4 | 19.6 | 13.2 | 18.8 | 13.8 | 17.8 |
| | | | | | H₂O₂ | | | | | | | | |

### Example 8

### Determination of the Minimum Amount of Water Needed to Generate Oxygen from SPC

Five volumetric cylinders filled to an arbitrary level with water were each suspended over a beaker of water to create 5 water columns. 5 flasks containing 2 g of SPC and 1 mg of MnO₂ (catalyst) were then each sealed with a rubber septum and tubing was run from each flask to the bottom of one of the water columns. Varying amounts of water was then added to the SPC and MnO₂ (as set forth in Table 4), and the amount of oxygen generated was measured at various timepoints using a Mocon Dual Headspace Analyzer (Model No. 260). The flasks were not shaken so that the contents of each flask were not mixed, but left together as they would be in an oxygen generating device.

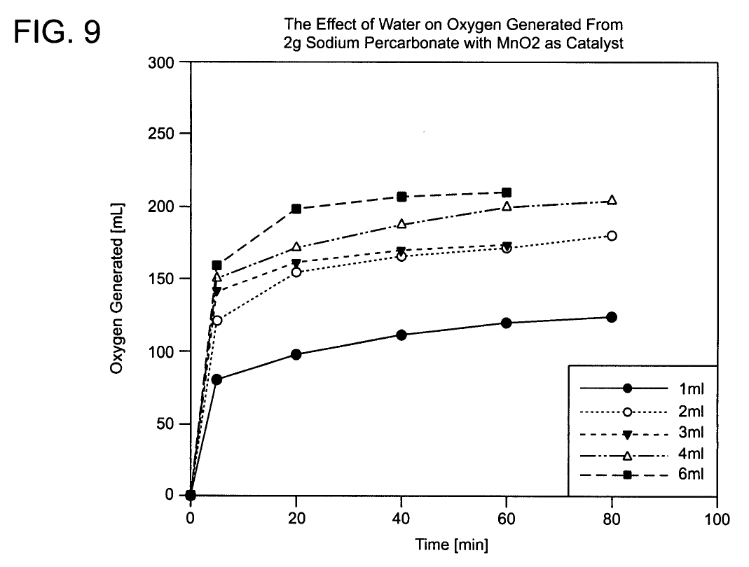

Data is provided in Table 4, below, and graphically represented in FIG. 9. From the data, 1 mL of water injected into a flask containing 2 g of SPC was not enough to generate a sufficient amount of oxygen, as the water did not wet all of the solid material. Injecting 6 mL of water generated most of the available oxygen in the first 20 minutes, dissolving all solid material within 60 minutes. Based on the results, it was determined that at least 2 mL of water is needed to efficiently generate oxygen from 2 g of SPC.

TABLE 4
Effect on Water Generated from 2 g SPC + Catalyst

| | Amt. SPC | Amt. MnO₂ | Amt. H₂O | Timept. | Amt O₂ |
|---|---|---|---|---|---|
| Flask # | (g) | (mg) | (mL) | (min) | Gen. (mL) |
| 1 | 2 | 1 | 1 | 0 | 0 |
| | | | | 5 | 80 |
| | | | | 20 | 97 |
| | | | | 40 | 110 |
| | | | | 60 | 118 |
| | | | | 80 | 122 |
| 2 | 2 | 1 | 2 | 0 | 0 |
| | | | | 5 | 120 |
| | | | | 20 | 153 |
| | | | | 40 | 164 |
| | | | | 60 | 170 |
| | | | | 80 | 178 |
| 3 | 2 | 1 | 3 | 0 | 0 |
| | | | | 5 | 140 |
| | | | | 20 | 160 |
| | | | | 40 | 168 |
| | | | | 60 | 172 |
| 4 | 2 | 1 | 4 | 0 | 0 |
| | | | | 5 | 150 |
| | | | | 20 | 170 |
| | | | | 40 | 186 |
| | | | | 60 | 198 |
| | | | | 80 | 202 |
| 5 | 2 | 1 | 6 | 0 | 0 |
| | | | | 5 | 158 |
| | | | | 20 | 197 |
| | | | | 40 | 205 |
| | | | | 60 | 208 |

### Example 9

### Determination of the Amount of Catalase+SPC Needed to Generate Oxygen

A 1.35 mg/mL (35100 units/mL) aqueous solution of catalase (purchased from Sigma-Aldrich Corporation, St. Louis, Mo., United States of America) was used to prepare 3 stock catalase solutions (in water), as indicated in Table 5, below.

TABLE 5
Catalase Stock Solutions

| | | | Final Conc. |
|---|---|---|---|
| Sol. # | Catalase added (mL) | Total Vol. (mL) | (units/mL) |
| 1 | 1 | 25 | 1040 |
| 2 | 2 | 50 | 520 |
| 3 | 3 | 100 | 260 |

Three volumetric cylinders were filled to an arbitrary level with water and suspended over a beaker of water to create 3 water columns. 3 flasks containing 2 g of SPC were then sealed with a rubber septum and tubing was run from each flask to the bottom of a water column. 4 mL of the 1040 units/mL catalase solution was then injected into the first flask; 4 mL of the 520 units/mL catalase solution was then injected into the second flask; and 4 mL of the 260 units/mL catalase solution was injected into the third flask. The volume of oxygen generated was then recorded by taking initial and final readings on the volumetric cylinders.

Results are provided in Table 6, below. The data indicates that the higher concentration of catalase resulted in more efficient oxygen generation compared to the lower concentrations of catalase.

TABLE 6
Volume of Oxygen Generated in Catalase + SPC Reactions

| | Amt. Catalase | | | | Vol. O₂ gen. |
|---|---|---|---|---|---|
| Rxn # | (units) | Amt. SPC (g) | Timept. | | (mL) |
| 1 | 4160 | 2 | 5 | min | 90 |
| | | | 10 | min | 106 |
| | | | 20 | min | 118 |
| | | | 40 | min | 130 |
| | | | 50 | min | 138 |
| | | | 240 | min | 176 |
| | | | 20 | hrs | 192 |
| 2 | 2080 | 2 | 5 | min | 72 |
| | | | 10 | min | 94 |
| | | | 20 | min | 110 |
| | | | 40 | min | 116 |
| | | | 50 | min | 122 |
| | | | 240 | min | 152 |
| | | | 20 | hrs | 184 |
| 3 | 1040 | 2 | 5 | min | 68 |
| | | | 10 | min | 89 |
| | | | 20 | min | 104 |
| | | | 30 | min | 110 |
| | | | 50 | min | 114 |
| | | | 240 | min | 130 |
| | | | 20 | hrs | 180 |

### Example 10

### Manufacture of an Oxygen Generating Sachet

An oxygen generating 2-chamber sachet was produced and filled with 2 g SPC in one chamber and 4 mL of a 260 units/mL catalase solution (1040 units) in the other. The 2 chambers were separated by a frangible seal.

Pouches were prepared using 3.5 barrier film (T7235B, available from Sealed Air Corporation, Duncan, S.C., United States of America). The 2-component pouches were heat sealed on an Impulse Sealer with a magnet (Model AIE-405HIM, manufactured by American International Electric, Inc., Whittier, Calif., United States of America) with heating set to 4.5 and cooling set to 6.5. The chambers of the sachet were separated by a frangible seal, prepared by placing a segment of easy-open barrier sealant film (P401 U, available from Sealed Air Corporation, Duncan, S.C., United States of America) in the seal area between the chambers of the sachet before the seal was made. Perforations were constructed manually using a syringe (G20 needle).

### Example 11

### Manufacture of Case Ready Packages

A CS975 Cryovac® solid barrier polypropylene tray (available from Sealed Air Corporation, Duncan, S.C., United States of America) was sealed with a Cryovac® Mirabella® barrier lidding film (available from Sealed Air Corporation, Duncan, S.C., United States of America) using a Mondini E340 (available from G. Mondini, S.P.A., Brescia, Italy) at a sealing temperature of 135° C. and a sealing time of 0.05 seconds.

### Example 12

### Testing of the Oxygen Generating Sachet

The sachet produced in Example 10 was then tested in a case ready tray of the type manufactured in Example 11. About 450 grams of freshly cut rib eye steak was placed within the tray. The sachet of Example 10 was then placed on a custom molded triangular ledge provided in the tray. The tray was then sealed as noted in Example 11 under low oxygen atmosphere (80:20 N₂:CO₂, with less than about 0.05% oxygen). Five packages were prepared.

The packages were stored in a cooler at 40° C. for about 16 hours. The sachets were then activated by manually pressing the liquid (catalase) portion of the sachet to break the frangible seal. Oxygen began to generate immediately, pressurizing the sachet and escaping through the sachet perforations into the tray headspace.

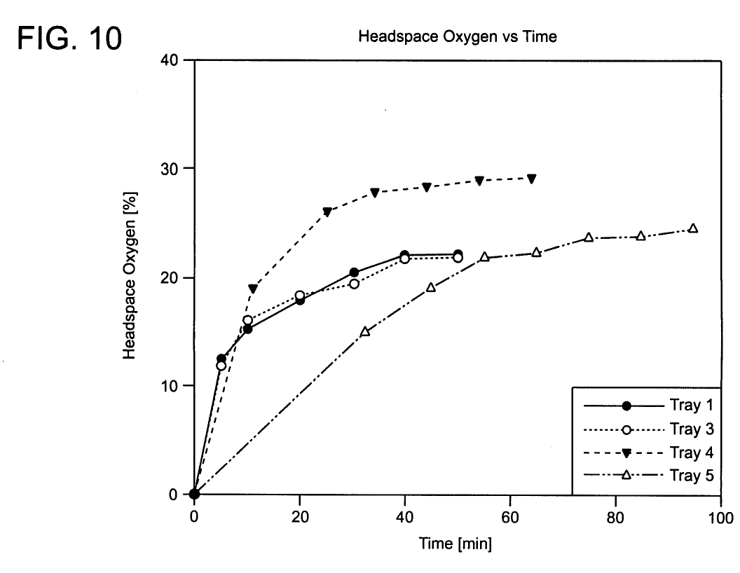

The oxygen content in the tray headspace was then monitored using a Mocon® Dual Headspace Oxygen Analyzer (Model No. 360) and is provided below in Table 7 and FIG. 10. No data was generated for Tray 2 because the oxygen generation sachet was plugged.

The results indicate that oxygen levels in the tray headspace reached about 20% within the first 15 to 20 minutes in all trays except Tray #5, where it was observed that the perforations were blocked, preventing oxygen from entering the tray headspace until an additional hole was made in the sachet using a syringe needle. In addition, the packaged meat bloomed to a red color as desired.

TABLE 7
Sachet Oxygen Generation Time course

| | | Oxygen Concentration |
|---|---|---|
| Tray # | Time point (min) | (%) |
| 1 | 10 | 15.2 |
| | 20 | 17.9 |
| | 30 | 20.5 |
| | 40 | 22.0 |
| | 50 | 22.1 |
| 3 | 0 | 0.01 |
| | 5 | 12.3 |
| | 10 | 16.0 |
| | 20 | 18.3 |
| | 30 | 19.4 |
| | 40 | 21.8 |
| | 50 | 21.9 |
| 4 | 0 | 0.1 |
| | 11 | 19.0 |
| | 25 | 25.0 |
| | 34 | 34.0 |
| | 44 | 44.0 |
| | 54 | 28.9 |
| | 64 | 29.1 |
| 5 | 0 | 0.1 |
| | 32 | 14.9 |
| | 45 | 19.0 |
| | 55 | 21.9 |
| | 65 | 22.3 |
| | 7 | 23.7 |
| | 85 | 23.8 |
| | 95 | 24.5 |

### Example 13

### Evaluation of SPC Stability in a Sachet

To determine what effect the presence of moisture from a humid meat tray atmosphere has on the oxygen-generation reaction, two 2-chamber sachets of Example 10 were placed on a triangular ledge inserted into 2 case ready trays of the type manufactured in Example 1. A wet soaker pad was added to each tray to provide moisture. The trays were sealed as in Example 1 under low oxygen atmosphere (initial oxygen levels were 180, 298 ppm in trays 1 and 2, respectively). The oxygen level was then monitored using a Mocon Dual Headspace Analyzer (Model No. 260) for 6 days.

The results are indicated below in Table 8 and are graphically presented in FIG. 10. The data indicates that SPC generated oxygen slowly with little moisture that entered through the perforations in the sachet. To prevent the early oxygen generation in the package, solid SPC should be hermetically sealed to prevent undesired contact with moisture.

TABLE 8
Concentration in Tray Headspace

| Tray # | Timept (hrs) | Conc. O₂ (%) |
|---|---|---|
| 1 | 16 | 0.122 |
| | 24 | 1.33 |
| | 40 | 3.43 |
| | 64 | 6.69 |
| | 72 | 7.70 |
| | 136 | 9.37 |
| 2 | 16 | 0.422 |
| | 24 | 1.06 |
| | 40 | 3.17 |
| | 64 | 5.14 |
| | 72 | 6.15 |
| | 136 | 9.10 |

What is claimed is:

1. A package that enables on-demand oxygen generation within the interior of the package, said package comprising:
a. an article that encompasses an enclosed space;
b. a product disposed within said article;
c. an oxygen generating device disposed on an interior or exterior surface of said article, wherein said oxygen generating device comprises two or more components that can react on demand to produce oxygen; and wherein said oxygen generating device comprises a means to allow oxygen to flow into the interior of the article.

2. The package of claim 1, wherein said article is selected from the group comprising a: tray, bottle, box, jar, pouch, blister package, carton, bag, sachet, or combinations thereof.

3. The package of claim 1, wherein said two or more components are selected from the group comprising: peroxide and catalyst, metal peroxide and water, percarbonate and water, perborate and water, superoxide and water, persulfate salt of a Group I or II metal and water, and combinations thereof.

4. The package of claim 3, wherein said catalyst is selected from the group comprising: transition metals, transition metal oxides, catalase, superoxide dismutase, peroxidase, and combinations thereof.

5. A method of packaging a product in an article that enables on-demand oxygen generation within the interior of the article, said method comprising:
a. supplying an article that encompasses an enclosed space;
b. disposing a product within the interior of said article;
c. disposing an oxygen generating device on an interior or exterior surface of the article, wherein said oxygen generating device comprises two or more components that can react on demand to produce oxygen, and wherein said oxygen generating device comprises a means to allow oxygen to flow into the interior of the article;
d. sealing the article; and
e. initiating the oxygen generating device to generate oxygen within the interior of the article.

6. The method of claim 5, wherein said article is selected from the group comprising a: tray, bottle, box, jar, pouch, blister package, carton, bag, sachet, or combinations thereof.

7. The method of claim 5, wherein said two or more components are selected from the group comprising: peroxide and catalyst, metal peroxide and water, percarbonate and water, perborate and water, superoxide and water, persulfate salt of a Group I or II metal and water, and combinations thereof.

8. The method of claim 7, wherein said catalyst is selected from the group comprising transition metals, transition metal oxides, catalase, superoxide dismutase, peroxidase, and combinations thereof.

9. A method of promoting blooming of fresh red meat, the method comprising the steps of:
a. supplying an article that encompasses an enclosed space;
b. disposing an amount of fresh red meat within the interior of said article;
c. disposing an oxygen generating device on an interior or exterior surface of the article, wherein said oxygen generating device comprises two or more components that can react on demand to produce oxygen, and wherein said oxygen generating device comprises a means to allow oxygen to flow into the interior of the article;
d. sealing the article; and
e. initiating the oxygen generating device to generate oxygen within the interior of the article.

10. The method of claim 9, wherein said article is selected from the group comprising a: tray, bottle, box, jar, pouch, blister package, carton, bag, sachet, or combinations thereof.

11. The method of claim 9, wherein said two or more components are selected from the group comprising: peroxide and catalyst, metal peroxide and water, percarbonate and water, perborate and water, superoxide and water, persulfate salt of a Group I or II metal and water, and combinations thereof.

12. The method of claim 11, wherein said catalyst is selected from the group comprising transition metals, transition metal oxides, catalase, superoxide dismutase, peroxidase, and combinations thereof.

13. An article that enables on-demand oxygen generation within the interior of the article, said article comprising:
a. an enclosed space; and
b. an oxygen generating device disposed on an interior or exterior surface of said article, wherein said oxygen generating device comprises two or more components that can react on demand to generate oxygen; and wherein said oxygen generating device comprises a means to allow oxygen to flow into the interior of the article.

14. The article of claim 13, wherein said article is selected from the group comprising a: tray, bottle, box, jar, pouch, blister package, carton, bag, sachet, or combinations thereof.

15. The article of claim 13, wherein said two or more components are selected from the group comprising: peroxide and catalyst, metal peroxide and water, percarbonate and water, perborate and water, superoxide and water, persulfate salt of a Group I or II metal and water, and combinations thereof.
